(19) United States
(12) Patent Application Publication
(10) Pub. No.: US 2018/0272526 A1
(43) Pub. Date: Sep. 27, 2018

(54) CONTROL DEVICE, TEACHING DEVICE, AND ROBOT SYSTEM

(71) Applicant: Seiko Epson Corporation, Tokyo (JP)

(72) Inventor: Yoshiki NAGASHIMA, Shiojiri (JP)

(21) Appl. No.: 15/924,719

(22) Filed: Mar. 19, 2018

(30) Foreign Application Priority Data
Mar. 21, 2017 (JP) 2017-054065
Jan. 25, 2018 (JP) 2018-010213

(51) Int. Cl. B25J 9/00; B25J 9/02; B25J 9/16

(52) U.S. Cl. CPC B25J 9/0081; Y10S 901/04; B25J 9/1664; B25J 9/02

(57) ABSTRACT

A control device includes a processor that is configured to be capable of displaying, on a display, a first setting form capable of setting a plurality of first setting items related to force control performed using an output of a force sensor included in a robot and a second setting form capable of setting, as one second setting item, at least a pair of the first setting items among the plurality of first setting items included in the first setting form.

### BACKGROUND

### 1. Technical Field

The present invention relates to a control device, a teaching device, and a robot system.

### 2. Related Art

Researches and developments of techniques concerning direct teaching of robots have been performed. The “direct teaching” is a teaching method in which a user applies an external force to a movable section of a robot and matches the position and the posture of the movable section with a position and a posture desired by the user to thereby teach the position and the posture to the robot.

A robot teaching device disclosed in JP-A-2012-157946 (Patent Literature 1) performs force control with an operation force applied to an operation section to move a robot and teaches the position and the posture of the robot to the robot. The robot teaching device includes a force detecting section that detects a force in at least one axial direction and moments around respective axes in two axial directions orthogonal to the one axial direction and orthogonal to each other. The robot teaching device performs the force control on the basis of the force detected by the force detecting section connected to the operation section. The robot teaching device disclosed in Patent Literature 1 is disposed to set a coordinate-system center point of the force detecting section and a point of action of a force to positions different from each other. The robot teaching device further includes a movement-reference-coordinate-system setting section that sets a movement reference coordinate system set as a reference when moving the robot, a moving-method setting section that sets a moving method for selecting whether to rotationally move the robot around the origin of the movement reference coordinate system or to translate the robot on the basis of the movement reference coordinate system, an imaginary-force calculating section that calculates an imaginary force at an action reference point on the basis of the force in the one axial direction, the moments around the respective axes in the two axial directions, and a position of a predetermined action reference point, a force-control-acting-force calculating section that calculates a force control acting force on the robot on the basis of the movement reference coordinate system set by the movement-reference-coordinate-system setting section, the moving method set by the moving-method setting section, and the imaginary force calculated by the imaginary-force calculating section, and a force control section that performs force control on the basis of the force control acting force.

In such a robot teaching device, a plurality of setting items related to the force control carried out in the direct teaching are set in advance before the direct teaching is performed. However, in the robot teaching device, there are a large number of the setting items and the setting of the setting items is complicated. Therefore, for example, in a robot teaching device in the past, for users except users proficient in the setting of the plurality of setting items (i.e., experts), it is sometimes difficult to perform the setting.

For example, if the number of items to be set is reduced, the difficulty in the setting decreases. As a result, even users nonproficient in the setting of the plurality of setting items related to the force control are capable of setting the plurality of setting items related to the force control. However, when the number of the setting items is reduced, flexibility of the setting related to the force control decreases. It is likely that the performance of the robot cannot be sufficiently exhibited.

Therefore, there have been demands for a technique for enabling a user nonproficient in setting to easily set a setting value and enabling a user proficient in the setting to appropriately set a plurality of setting values.

### SUMMARY

According to an aspect of the invention, a control device that controls a robot is provided. The control device includes: a processor that is configured to execute computer-executable instructions so as to control the robot, wherein the processor is configured to: set, by referring to a memory having stored therein a plurality of sets of information in which setting values of at least two first setting items among a plurality of first setting items related to force control performed using an output from a force sensor included in a robot and one setting value of a second setting item are associated, when a setting value of the second setting item is selected, set the setting values of the at least two first setting items associated with the selected setting value of the second setting item; and display, on a display, a first setting form capable of individually setting setting values of the plurality of first setting items and a second setting form incapable of individually setting the setting values of the at least two first setting items, the setting value of which is associated with the one setting value of the second setting item, and capable of setting the setting value of the second setting item.

### BRIEF DESCRIPTION OF THE DRAWINGS

The invention will be described with reference to the accompanying drawings, wherein like numbers reference like elements.

FIG. 1 is a diagram showing an example of the configuration of a robot system according to a first embodiment.

FIG. 2 is a diagram showing an example of a hardware configuration of a teaching device.

FIG. 3 is a diagram showing an example of a functional configuration of the teaching device.

FIG. 4 is a diagram showing an example of a first setting form that the teaching device causes a display section to display in a first operation mode.

FIG. 5 is a diagram showing an example of a screen displayed when a pulldown menu on the screen shown in FIG. 4 is clicked (tapped) by a user.

FIG. 6 is a diagram showing an example of a second setting form that the teaching device causes the display section to display in a second operation mode.

FIG. 7 is a diagram showing an example of a screen displayed when a pulldown menu on the screen shown in FIG. 6 is clicked (tapped) by the user.

FIG. 8 is a diagram showing an example of the screen displayed when linear motion form information is clicked by the user in a list shown in FIG. 7.

FIG. 9 is a diagram showing an example of the screen displayed when plane motion form information is clicked by the user in the list shown in FIG. 7.

FIG. 10 is a diagram showing an example of the screen displayed when rotational motion form information is clicked by the user in the list shown in FIG. 7.

FIG. 11 is a diagram showing an example of the screen displayed when custom motion form information is clicked by the user in the list shown in FIG. 7.

FIG. 12 is a diagram showing an example of the screen displayed when a tab on the screen shown in FIG. 6 is clicked (tapped) by the user.

FIG. 13 is a diagram showing an example of a graph.

FIG. 14 is a diagram of an example of a graph.

FIG. 15 is a diagram showing an example of a screen.

FIG. 16 is a diagram showing another example of the screen.

FIG. 17 is a diagram showing still another example of the screen.

### DESCRIPTION OF EXEMPLARY EMBODIMENTS

### A. First Embodiment

A first embodiment of the invention is explained below with reference to the drawing.

### A1. Configuration of a Robot System

First, the configuration of a robot system 1 is explained.

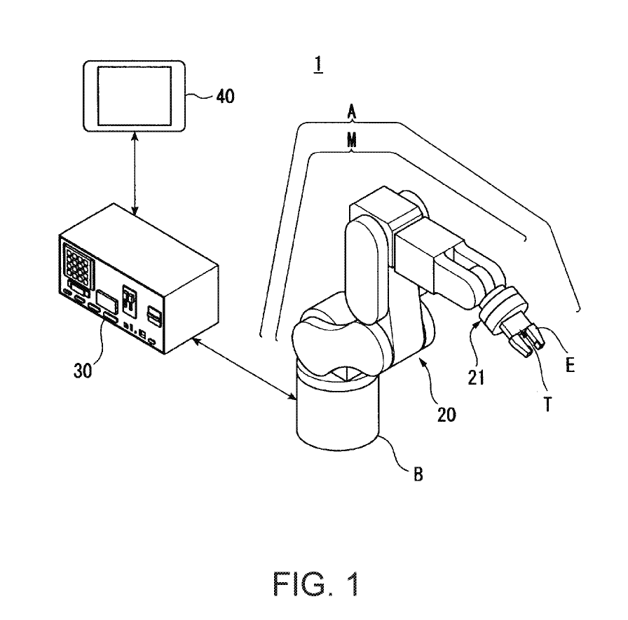

FIG. 1 is a diagram showing an example of the configuration of the robot system 1 according to the first embodiment. The robot system 1 includes a robot 20, a robot control device 30, and a teaching device 40.

Note that, in the robot system 1 in this embodiment, the robot 20 and the robot control device 30 are separately configured. However, instead, the robot 20 and the robot control device 30 may be integrally configured. In this case, the robot system 1 includes the robot 20 configured integrally with the robot control device 30 and the teaching device 40. In this case, the robot control device 30 is incorporated in the robot 20.

The robot 20 is a single-arm robot including a movable section A and a supporting table B that supports the movable section A. The single-arm robot is a robot including one arm like the movable section A in this example. Note that the robot 20 maybe a plural-arm robot instead of the single-arm robot. The plural-arm robot is a robot including two or more arms (e.g., two or more movable sections A). Note that, among plural-arm robots, a robot including two arms (e.g., two movable sections A) is called double-arm robot as well. That is, the robot 20 may be a double-arm robot including two arms or may be a plural-arm robot including three or more arms (e.g., three or more movable sections A). The robot 20 may be another robot such as a SCARA robot, a Cartesian coordinate robot, or a cylindrical robot. The Cartesian coordinate robot is, for example, a gantry robot.

The movable section A includes an end effector E, a manipulator M, and a force detecting section 21.

In this example, the end effector E is an end effector including a finger section capable of gripping an object. Note that, instead of the end effector including the finger section, the end effector E may be another end effector capable of lifting an object with suction of the air, a magnetic force, a jig, or the like or may be another end effector not used to lift an object.

The end effector E is communicably connected to the robot control device 30 by a cable. Consequently, the end effector E performs operation based on a control signal acquired from the robot control device 30. Note that wired communication via the cable is performed according to a standard such as the Ethernet (registered trademark) or the USB. The end effector E may be connected to the robot control device 30 by wireless communication performed according to a communication standard such as the Wi-Fi (registered trademark).

The manipulator M includes six joints. The six joints respectively include not-shown actuators. That is, the movable section A including the manipulator M is an arm of a six-axis vertical articulated type. The movable section A performs operation having a six-axis degree of freedom according to associated operation by the supporting table B, the end effector E, the manipulator M, and the actuators of the respective six joints included in the manipulator M. Note that the movable section A may be configured to operate at a five-axis or less degree of freedom or may be configured to operate at a seven-axis or more degree of freedom.

The six actuators (included in six joints) included in the manipulator M are respectively communicably connected to the robot control device 30 by a cable. Consequently, the actuators operate the manipulator M on the basis of a control signal acquired from the robot control device 30. Note that wired communication via the cable is performed according to a standard such as the Ethernet (registered trademark) or the USB. A part of all of the six actuators included in the manipulator M may be connected to the robot control device 30 by wireless communication performed according to a communication standard such as the Wi-Fi (registered trademark).

The force detecting section 21 is provided between the end effector E and the manipulator M. The force detecting section 21 is, for example, a force sensor. The force detecting section 21 detects an external force acting on (applied to) the distal end of the movable section A. In this example, the distal end of the movable section A refers to the end effector E or an object gripped by the end effector E. The external force acting on the distal end of the movable section A refers to at least one of a force and a moment (torque) acting on the distal end. The force detecting section 21 outputs force detection information including, as an output value, a value indicating the magnitude of the detected external force to the robot control device 30 through communication. Note that the force detecting section 21 may be another sensor that detects a value indicating the magnitude of the external force acting on the distal end such as a torque sensor.

The force detection information is used for force control performed using the force detection information of the movable section A (control based on the force detection information) by the robot control device 30. The control performed using the force detection information refers to compliant motion control such as impedance control. The force detection information is an example of an output from the force detecting section 21.

The force detecting section 21 is communicably connected to the robot control device 30 by a cable. Wired communication via the cable is performed according to a standard such as the Ethernet (registered trademark) or the USB. Note that the force detecting section 21 and the robot control device 30 may be connected by wireless communication performed according to a communication standard such as the Wi-Fi (registered trademark).

In this example, the robot control device 30 is a controller that controls (operates) the robot. The robot control device 30 sets a control point T, which is an imaginary point that moves together with the end effector E, in a position associated with the end effector E in advance. The control point T is, for example, a TCP (Tool Center Point). In the following explanation, as an example, the position associated with the end effector E in advance is the position of the center of gravity of the end effector E. Note that, instead, the position associated with the end effector E in advance may be another position associated with the end effector E. The control point T may be set in another position associated with the movable section A in advance instead of the position associated with the end effector E in advance.

Control point position information, which is information indicating the position of the control point T, and control point posture information, which is information indicating the posture of the control point T, are associated with the control point T. Note that, in addition to these kinds of information, other information may be associated with the control point T. When the robot control device 30 designates (determines) the control point position information and the control point posture information, the position and the posture of the control point T are determined. The robot control device 30 designates control point position information and operates the movable section A such that the position of the control point T coincides with a position indicated by the designated control point position information. The robot control device 30 designates control point posture information and operates the movable section A such that the posture of the control point T coincides with a posture indicated by the designated control point posture information.

In this example, the position of the control point T is represented by a position in a robot coordinate system of the origin of a control point coordinate system, which is a three-dimensional local coordinate system, associated with the control point T to move together with the control point T. The posture of the control point T is represented by directions in the robot coordinate system of coordinate axes of the control point coordinate system.

The robot control device 30 sets the control point T on the basis of control point setting information input from the user in advance. The control point setting information is, for example, information indicating relative positions and postures of the position and the posture of the center of gravity of the end effector E and the position and the posture of the control point T. Note that, instead, the control point setting information may be information indicating relative positions and postures of some position and some posture associated with the movable section A and the position and the posture of the control point T.

The robot control device 30 is taught one or more kinds of teaching point information from the teaching device 40. Specifically, the robot control device 30 acquires one or more kinds of teaching point information from the teaching device 40. The robot control device 30 stores the acquired one or more kinds of teaching point information. The teaching point information is information indicating a teaching point. The teaching point is a plurality of imaginary points that the robot control device 30 causes the movable section A to pass when operating the movable section A. Teaching point position information and teaching point posture information are associated with the teaching point. The teaching point position information is information indicating the position of the teaching point. The teaching point posture information is information indicating the posture of the teaching point. Note that, in addition to the teaching point position information and the teaching point posture information, other information may be associated with the teaching point.

In this example, the position of a teaching point indicated by certain teaching point information is represented by a position in the robot coordinate system of the origin of a teaching point coordinate system, which is a three-dimensional local coordinate system, associated with the teaching point. The posture of the teaching point is represented by directions in the robot coordinate system of coordinate axes of the teaching point coordinate system.

The robot control device 30 designates, for example, on the basis of operation received from the user, control point position information indicating a position of a teaching point indicated by teaching point information designated by an operation program stored in advance and control point posture information indicating a posture of the teaching point. The robot control device 30 operates the movable section A, matches the position of the control point T with the position indicated by the designated control point position information, and matches the posture of the control point T with the posture of the designated control point posture information. Consequently, the robot control device 30 matches the control point T with the teaching point. That is, the robot control device 30 matches the position and the posture of the control point T with the position and the posture of the teaching point. The robot control device 30 matches, on the basis of the operation program, the control point T with teaching points indicated by respective kinds of teaching point information in order of designation by the operation program. Consequently, the robot control device 30 can cause the movable section A to perform a desired motion. As a result, the robot control device 30 can cause the robot 20 to perform predetermined work.

When changing the position and the posture of the control point T in this way, the robot control device 30 generates, on the basis of operation received from the user and on the basis of the operation program stored in advance and the teaching point information taught (i.e., acquired) from the teaching device 40, a control signal including a signal for controlling the actuators of the manipulator M. The control signal also includes other signals such as a signal for moving the finger section of the end effector E. The robot control device 30 transmits the generated control signal to the robot 20 and causes the robot 20 to perform predetermined work.

When acquiring a request for a start of the direct teaching from the teaching device 40 and when a not-shown enable switch included in the teaching device 40 is pressed, the robot control device 30 starts (enables) force control of the manipulator M (i.e., operation of the manipulator M by the force control). The enable switch is a switch for causing, when being pressed, the robot control device 30 to enable the force control of the manipulator M (i.e., the operation of the manipulator M by the force control) by the robot control device 30. Specifically, in this case, the robot control device 30 acquires force detection information from the force detecting section 21. The robot control device 30 operates the manipulator M with force control using the acquired force detection information and changes the position and the posture of the control point T. Consequently, the user can match the position and the posture of the control point T with a desired position and a desired posture by manually moving the manipulator M (i.e., moving the position and the posture of the control point T) and perform the direct teaching for teaching the robot control device 30 teaching point information indicating a teaching point associated with teaching point position information indicating the position and teaching point posture information indicating the posture.

Note that, in this specification, moving the position and the posture of the control point T of the robot 20 is sometimes simply described as “moving the robot 20”. Both of a direction in which the control point T of the robot 20 is moveable and a direction in which the control point T is rotatable are sometimes simply referred to as “a direction in which the robot 20 is movable”.

In the direct teaching, the robot control device 30 performs force control on the basis of first setting information set in a first setting item in advance. The robot control device 30 receives the direct teaching from the user according to the position and the posture of the control point T of the movable section A of the robot 20, the position and the posture of which are designated by an external force applied by the user, and an instruction by the user via the teaching device 40.

On the other hand, when receiving the request for the start of the direct teaching from the teaching device 40 and when the enable switch included in the teaching device 40 is not pressed, the robot control device 30 does not start (disables) the force control of the manipulator M (i.e., the operation of the manipulator M by the force control). Specifically, in this case, since the robot control device 30 does not operate the manipulator M, the robot control device 30 does not change the position and the posture of the control point T even if an external force is received from the user. When not acquiring the request for the start of the direct teaching from the teaching device 40, as in this case, the robot control device 30 does not start (disables) the force control of the manipulator M.

The teaching device 40 is, for example, a teaching pendant. The teaching device 40 sets, on the basis of operation received from the user, each of a plurality of the first setting items in the robot control device 30. As a result, the robot 20 is taught a motion. Specifically, the teaching device 40 receives a plurality of kinds of the first setting information on the basis of the operation and causes the robot control device 30 to store the received plurality of kinds of first setting information. In this case, each of the plurality of kinds of first setting information includes information indicating the first setting item. For example, certain first setting information includes information indicating the first setting item associated with the first setting information. Therefore, the robot control device 30 is capable of distinguishing in which first setting item each of the plurality of kinds of first setting information is set. In the following explanation, to simplify the explanation, explanation concerning information indicating the first setting item is omitted.

The teaching device 40 generates teaching point information on the basis of operation received from the user. When generating the teaching point information, the teaching device 40 acquires information indicating the present position and the present posture of the control point T from the robot control device 30. The teaching device 40 specifies the position and the posture of the control point T indicated by the acquired information as a position and a posture of a teaching point. The teaching device 40 generates teaching point information indicating the teaching point associated with teaching point position information indicating the specified position of the teaching point and teaching point posture information indicating the specified posture of the teaching point. The teaching device 40 teaches the generated teaching point information to the robot control device 30. That is, the teaching device 40 outputs the teaching point information to the robot control device 30 and causes the robot control device 30 to store the teaching point information.

The teaching device 40 is communicable connected to the robot control device 30 by a cable. Wired communication via the cable is performed according to a standard such as the Ethernet (registered trademark) or the USB. Note that the teaching device 40 and the robot control device 30 may be connected by wireless communication performed according to a communication standard such as the Wi-Fi (registered trademark).

### A2. Overview of Processing Performed by the Teaching Device when the First Setting Item is Set in the Robot Control Device

An overview of processing performed by the teaching device 40 when setting the first setting item in the robot control device 30 is explained below.

When the direct teaching is performed, in a robot control device X (e.g., the robot control device in the past) different from the robot control device 30, a plurality of setting items related to force control in the direct teaching need to be set in advance. However, in the robot control device X, there are a large number of the setting items and the setting of the plurality of setting items is complicated. It is sometimes difficult to set the plurality of setting items in advance. In particular, in the robot control device X, for users except users (i.e., skilled people or experts) proficient in the setting of the plurality of setting items, it is sometimes difficult to perform the setting.

Therefore, when performing the direct teaching, the teaching device 40 is capable of displaying a first setting form capable of setting a plurality of first setting items related to force control performed using an output (in this example, force detection information) from the force detecting section 21 included in the robot 20 and a second setting form capable of setting, as one second setting item, at least two first setting items among the plurality of first setting items included in the first setting form.

The first setting form refers to a screen designed for users (e.g., skilled people or experts) proficient in setting of a plurality of first setting items for the robot control device 30 and refers to a screen on which each of the plurality of first setting items can be individually set in the robot control device 30 by the teaching device 40. Note that the first setting form may be designed for other users instead of being designed for the users.

The second setting form refers to a screen designed for users (e.g., novices or beginners) nonproficient in the setting of the plurality of first setting items for the robot control device 30 and refers to a screen on which at least a part (at least two) of the plurality of first setting items can be collectively set in the robot control device 30 as one second setting item by the teaching device 40. In this case, the second setting item is a setting item in which even the users can easily understand content to be set compared with the respective plurality of first setting items set by the second setting item. In the second setting form, a setting value of the second setting item can be set. On the other hand, in the second setting form, one setting value of the second setting item and setting values of the plurality of first setting items associated with setting values cannot be individually set.

In the following explanation, each of one or more kinds of information that can be set in the second setting item is referred to as “second setting information”. The second setting item may be only one second setting item or may be a plurality of second setting items. Note that, even when the second setting item is the plurality of second setting items, a part or all of a plurality of first setting items set by a certain second setting item are not included in a plurality of first setting items set by another second setting item. The second setting form may be designed for other users instead of being designed for the users of the second setting form. In the following explanation, for convenience of the explanation, setting, in the second setting item among setting items that can be set in the teaching device 40, the second setting information corresponding to the second setting item is referred to as “setting the second setting item in the teaching device 40”.

When certain information is set in a certain second setting item, in the teaching device 40, the first setting information corresponding to the information is set in each of one or more first setting items set by the second setting item, that is, first setting items that can be set in the robot control device 30. An example is explained in which the first setting information that can be set in a certain first setting item Q11 is either one of “A” and “B”, the first setting information that can be set in another first setting item Q12 is either one of “C” and “D”, the second setting information that can be set in a certain second setting item Q21 is either one of “E” and “F”, the first setting information corresponding to “E” is “A” and “D”, and the first setting information corresponding to “F” is “B” and “C”. If “E” is set in the second setting item Q21 in the teaching device 40, since the first setting information corresponding to “E” is “A” and “D”, the teaching device 40 causes the robot control device 30 to store “A” and “D” and sets the first setting item Q11 and the first setting item Q12 in the robot control device 30. In this case, when “F” is set in the second setting item Q21 in the teaching device 40, since the first setting information corresponding to “F” is “B” and “C”, the teaching device 40 causes the robot control device 30 to store “B” and “C” and sets the first setting item Q11 and the first setting item Q12 in the robot control device 30. In this way, in the second setting form, by setting a certain second setting item, it is possible to set a plurality of first setting items that can be set by the second setting item. Consequently, for example, even when a user (e.g., a novice or a beginner) nonproficient in setting of the respective first setting items Q11 and Q12 does not known what “A”, “B”, “C”, and “D” respectively represent, the following effect can be obtained if the user can understand what each of “E” and “F” represents. That is, the teaching device 40 can cause the user to set the respective first setting items Q11 and Q12 by causing the user to set the second setting item Q21.

That is, the teaching device 40 can provide the second setting form capable of easily setting the plurality of first setting items related to the force control in the direct teaching. As a result, in the teaching device 40, even a user (e.g., a novice or a beginner) nonproficient in the setting of the plurality of first setting items can easily perform the setting. In the following explanation, for convenience of the explanation, an operation mode for displaying the first setting form among operation modes of the teaching device 40 is referred to as “first operation mode” and an operation mode for displaying the second setting form among the operation modes of the teaching device 40 is referred to as “second operation mode”. An operation mode of the teaching device 40 is selected by the user in a GUI of a selection screen displayed prior to the display of the first setting form and the second setting form and is input to the teaching device 40.

In the following explanation, processing performed by the teaching device 40 in each of the first operation mode and the second operation mode is explained in detail. Note that, in the following explanation, as explained above, the first setting item and the second setting item are the plurality of setting items related to the force control in the direct teaching. However, the first setting item and the second setting item may be setting items in force control in other than the direct teaching (e.g., impedance control in causing the robot 20 to perform predetermined work). In this case, each of the first setting form and the second setting form, the operation of the teaching device 40, and the operation of the robot control device 30 explained below is applied to setting of the setting items related to the force control.

### A3. Hardware Configuration of the Teaching Device

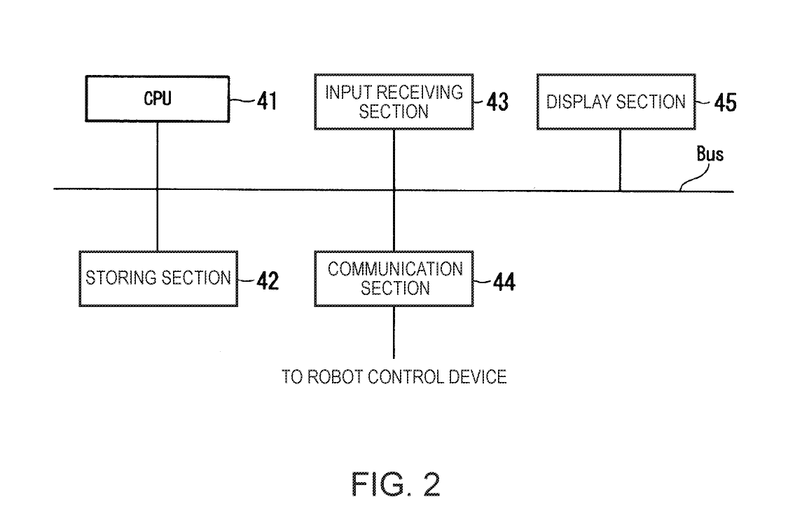

FIG. 2 is a diagram showing an example of a hardware configuration of the teaching device 40. In the following explanation, the hardware configuration of the teaching device 40 is explained below.

The teaching device 40 includes, for example, a processor such as a CPU (Central Processing Unit) 41, a storing section 42, an input receiving section 43, a communication section 44, and a display section 45. These components are mutually communicably connected via a bus Bus. The teaching device 40 performs communication with the robot control device 30 via the communication section 44.

The CPU 41 executes various computer programs stored in the storing section 42.

The storing section 42 includes, for example, a HDD (Hard Disk Drive), a SSD (Solid State Drive), an EEPROM (Electrically Erasable Programmable Read-Only Memory), a ROM (Read-Only Memory), and a RAM (Random Access Memory). Note that the storing section 42 may be an external storage connected by, for example, a digital input/output port such as the USB instead of a storage incorporated in the teaching device 40. The storing section 42 stores various kinds of information, various images, various computer programs including the operation program, and the teaching point information explained above processed by the teaching device 40.

For example, in the storing section 42, one setting value of the second setting item set by the user when performing setting of the robot 20 and setting values of eighteen first setting items related to the force control of the robot 20 are stored in association with each other. In the storing section 42, a plurality of sets of information in which setting values of the second setting information and setting values of the first setting items are associated are stored.

In the storing section 42, setting values of six first setting items for setting directions of two axes that a moving direction of the robot 20 can include as direction components in a three-dimensional orthogonal coordinate system and setting values of one second setting item are stored in association with each other. In the storing section 42, a plurality of sets of information in which the setting values of the second setting item and the setting values of the first setting items are associated are stored.

In the storing section 42, setting values of six first setting items for setting one direction among directions of axes as a movable direction and setting values of one second setting item are stored in association with each other. In the storing section 42, a plurality of sets of information in which the setting values of the second setting item and the setting values of the first setting items are associated are stored. These kinds of information stored in the storing section 42 are explained below.

The input receiving section 43 is, for example, a touch panel configured integrally with the display section 45. Note that the input receiving section 43 may be a keyboard and a mouse, a touch pad, or another input device. Note that, when the input receiving section 43 configures a head mounted display together with the display section 45, the input receiving section 43 may be a microphone for performing input by voice.

The communication section 44 includes, for example, a digital input/output port such as the USB or an Ethernet (registered trademark) port.

The display section 45 is, for example, a liquid crystal display panel or an organic EL (Electro Luminescence) display panel. Note that the display section 45 may be a display included in a wearable device such as a head mounted display.

### A4. Functional Configuration of the Teaching Device

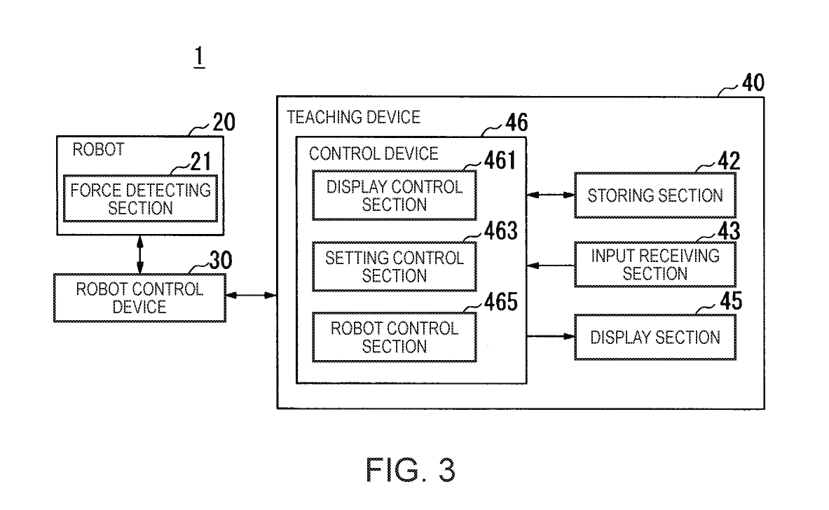

FIG. 3 is a diagram showing an example of a functional configuration of the teaching device 40. The functional configuration of the teaching device 40 is explained below with reference to FIG. 3.

The teaching device 40 includes a storing section 42, an input receiving section 43, a display section 45, and a control device 46.

Note that the teaching device 40 maybe separate from the control device 46. In this case, the robot control device 30 may include the control device 46. Another information processing device such as a desktop PC (Personal Computer), a notebook PC, a tablet PC, a multifunction cellular phone terminal (a smartphone), a cellular phone terminal, or a PDA (Personal Digital Assistant) may include the control device 46. In these cases, for example, for convenience in performing the direct teaching, the enable switch is desirably separate from the teaching device 40. When the enable switch is separate from the teaching device 40, the enable switch is included in a device portable by the user. The device is communicably connected to the robot control device 30 by radio or wire.

The control device 46 controls the entire teaching device 40. The control device 46 includes a display control section 461, a setting control section 463, and a robot control section 465. These functional sections included in the control device 46 are realized by, for example, the CPU 41 executing various computer programs stored in the storing section 42. A part or all of the functional sections may be hardware functional sections such as an LSI (Large Scale Integration) and an ASIC (Application Specific Integrated Circuit).

The display control section 461 generates various screens on the basis of operation received from the user. The display control section 461 causes the display section 45 to display the generated screens.

The setting control section 463 sets first setting items in the robot control device 30 on the basis of operation received from the user.

The robot control section 465 controls the robot control device 30 on the basis of operation received from the user and causes the robot control device 30 to operate the robot 20.

### A5. Specific Example of First Setting Items

A specific example of a plurality of first setting items related to the force control in the direct teaching among a plurality of setting items that the teaching device 40 can set in the robot control device 30 is explained below.

In this example, the plurality of first setting items related to the force control in the direct teaching among the plurality of setting items that the teaching device 40 can set in the robot control device 30 include twenty-six setting items (1) to (26) described below.
(1) Effectiveness and ineffectiveness of gravity compensation
(2) A reference coordinate system
(3) Propriety of translation of the control point T in a direction along an X axis in the reference coordinate system
(4) Propriety of translation of the control point T in a direction along a Y axis in the reference coordinate system
(5) Propriety of translation of the control point T in a direction along a Z axis in the reference coordinate system
(6) Propriety of rotation of the control point T in a direction along a U axis in the reference coordinate system
(7) Propriety of rotation of the control point T in a direction along a V axis in the reference coordinate system
(8) Propriety of rotation of the control point T in a direction along a W axis in the reference coordinate system
(9) A mass coefficient of force control with respect the direction along the X axis in the reference coordinate system
(10) A coefficient of elasticity of the force control with respect the direction along the X axis in the reference coordinate system
(11) A coefficient of viscosity of the force control with respect the direction along the X axis in the reference coordinate system
(12) A mass coefficient of force control with respect the direction along the Y axis in the reference coordinate system
(13) A coefficient of elasticity of the force control with respect the direction along the Y axis in the reference coordinate system
(14) A coefficient of viscosity of the force control with respect the direction along the Y axis in the reference coordinate system
(15) A mass coefficient of force control with respect the direction along the Z axis in the reference coordinate system
(16) A coefficient of elasticity of the force control with respect the direction along the Z axis in the reference coordinate system
(17) A coefficient of viscosity of the force control with respect the direction along the Z axis in the reference coordinate system
(18) A mass coefficient of force control with respect the direction along the U axis in the reference coordinate system
(19) A coefficient of elasticity of the force control with respect the direction along the U axis in the reference coordinate system
(20) A coefficient of viscosity of the force control with respect the direction along the U axis in the reference coordinate system
(21) A mass coefficient of force control with respect the direction along the V axis in the reference coordinate system
(22) A coefficient of elasticity of the force control with respect the direction along the V axis in the reference coordinate system
(23) A coefficient of viscosity of the force control with respect the direction along the V axis in the reference coordinate system
(24) A mass coefficient of force control with respect the direction along the W axis in the reference coordinate system
(25) A coefficient of elasticity of the force control with respect the direction along the W axis in the reference coordinate system
(26) A coefficient of viscosity of the force control with respect the direction along the W axis in the reference coordinate system

The U axis in the reference coordinate system refers to a coordinate axis indicating a rotation angle around the X axis in the reference coordinate system. The V axis in the reference coordinate system refers to a coordinate axis indicating a rotation angle around the Y axis in the reference coordinate system. The W axis in the reference coordinate system refers to a coordinate axis indicating a rotation angle around the Z axis in the reference coordinate system.

In the first setting item of (1), information indicating effectiveness of the gravity compensation or information indicating ineffectiveness of the gravity compensation is set as the first setting information.

In the first setting item of (2), information indicating a coordinate system selected as the reference coordinate system is set as the first setting information.

In the first setting item of (3), information indicating permission of translation of the control point T in the direction along the X axis in the reference coordinate system indicated by the setting information set in the first setting item of (2) or information indicating non-permission of the translation is set as the first setting information.

In the first setting item of (4), information indicating permission of translation of the control point T in the direction along the Y axis in the reference coordinate system or information indicating non-permission of the translation is set as the first setting information.

In the first setting item of (5), information indicating permission of translation of the control point T in the direction along the Z axis in the reference coordinate system and information indicating non-permission of the translation is set as the first setting information.

In the first setting item of (6), information indicating permission of rotation of the control point T in the direction along the U axis in the reference coordinate system or information indicating non-permission of the rotation is set as the first setting information.

In the first setting item of (7), information indicating permission of rotation of the control point T in the direction along the V axis in the reference coordinate system or information indicating non-permission of the rotation is set as the first setting information.

In the first setting item of (8), information indicating permission of rotation of the control point T in the direction along the W axis in the reference coordinate system or information indicating non-permission of the rotation is set as the first setting information.

In the first setting item of (9), a value of the mass coefficient of the force control with respect to the direction along the X axis is set as the first setting information.

In the first setting item of (10), a value of the coefficient of elasticity of the force control with respect to the direction along the X axis is set as the first setting information.

In the first setting item of (11), a value of the coefficient of viscosity of the force control with respect to the direction along the X axis is set as the first setting information.

In the first setting item of (12), a value of the mass coefficient of the force control with respect to the direction along the Y axis is set as the first setting information.

In the first setting item of (13), a value of the coefficient of elasticity of the force control with respect to the direction along the Y axis is set as the first setting information.

In the first setting item of (14), a value of the coefficient of viscosity of the force control with respect to the direction along the Y axis is set as the first setting information.

In the first setting item of (15), a value of the mass coefficient of the force control with respect to the direction along the Z axis is set as the first setting information.

In the first setting item of (16), a value of the coefficient of elasticity of the force control with respect to the direction along the Z axis is set as the first setting information.

In the first setting item of (17), a value of the coefficient of viscosity of the force control with respect to the direction along the Z axis is set as the first setting information.

In the first setting item of (18), a value of the mass coefficient of the force control with respect to the direction along the U axis is set as the first setting information.

In the first setting item of (19), a value of the coefficient of elasticity of the force control with respect to the direction along the U axis is set as the first setting information.

In the first setting item of (20), a value of the coefficient of viscosity of the force control with respect to the direction along the U axis is set as the first setting information.

In the first setting item of (21), a value of the mass coefficient of the force control with respect to the direction along the V axis is set as the first setting information.

In the first setting item of (22), a value of the coefficient of elasticity of the force control with respect to the direction along the V axis is set as the first setting information.

In the first setting item of (23), a value of the coefficient of viscosity of the force control with respect to the direction along the V axis is set as the first setting information.

In the first setting item of (24), a value of the mass coefficient of the force control with respect to the direction along the W axis is set as the first setting information.

In the first setting item of (25), a value of the coefficient of elasticity of the force control with respect to the direction along the W axis is set as the first setting information.

In the first setting item of (26), a value of the coefficient of viscosity of the force control with respect to the direction along the W axis is set as the first setting information.

Note that the plurality of first setting items related to the force control in the direct teaching among the plurality of setting items that the teaching device 40 can set in the robot control device 30 may include other setting items instead of a part or all of the twenty-six setting items or may include other setting items in addition to the twenty-six setting items.

### A6. File in which the First Setting Information Set in the First Setting Items is Stored

A file stored in a storage region of the robot control device 30 in which the first setting information set in the first setting items is stored is explained.

The teaching device 40 controls the robot control device 30 on the basis of operation received from the user and generates a “first high-order file”, which is a file to which a plurality of files belong (i.e., a directory higher in order or a folder higher in order than the plurality of files), in the storage region of the robot control device 30. The teaching device 40 can generate one or more first high-order files in the storage region on the basis of the operation received from the user. The teaching device 40 controls the robot control device 30 on the basis of operation received from the user and generates each of an “eleventh file”, a “twelfth file”, and a “thirteenth file”, which are three kinds of files belonging to the first high-order file, in the storage region.

The “eleventh file” is a file that stores, as the first setting information set in the first setting item of (1) described above, information indicating effectiveness of the gravity compensation or information indicating ineffectiveness of the gravity control. The “thirteenth file” is a file that stores, as the first setting information set in the first setting item of (2) described above, information indicating a coordinate system selected by the user as the reference coordinate system. The “twelfth file” is a file that stores, as the first setting information set in the first setting items of respective (3) to (26) described above, information explained below. The information is information indicating propriety of translation of the control point T in the direction along each of the X axis, the Y axis, and the Z axis in the reference coordinate system indicated by the information stored in the thirteenth file, information indicating propriety of rotation of the control point T in the direction along each of the U axis, the V axis, and the W axis in the reference coordinate system, and information indicating each of a mass coefficient, a coefficient of elasticity, and a coefficient of viscosity of force control with respect to the direction along each of the X axis, the Y axis, the Z axis, the U axis, the V axis, and the W axis.

Note that the teaching device 40 may be configured to store the first setting information set in the first setting items in a file having another file structure instead of storing the first setting information in any one of the eleventh file, the thirteenth file, and the twelfth file belonging to the first file. The teaching device 40 may be configured to store the first setting information set in the first setting items in the storing section 42 as well.

### A7. Processing Performed by the Teaching Device in a First Operation Mode

### A7-1. Initial Screen of the First Setting Form

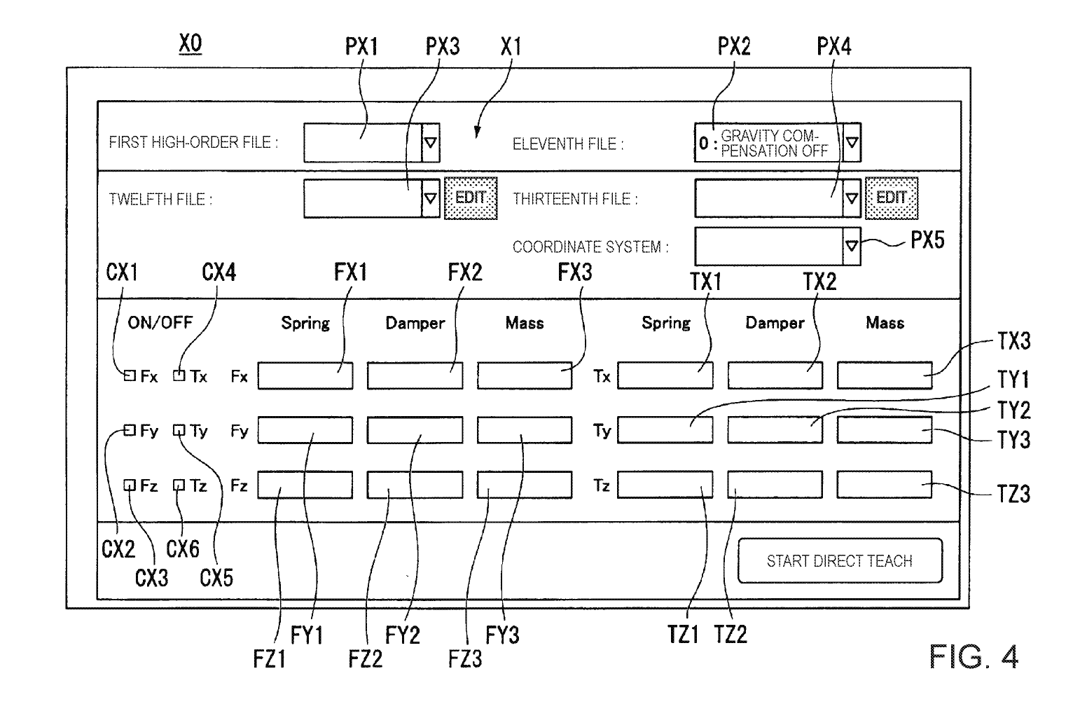

FIG. 4 is a diagram showing an example of the first setting form that the teaching device 40 causes the display section 45 to display in the first operation mode. Processing performed by the teaching device 40 in the first operation mode is explained below with reference to FIG. 4. A screen X0 shown in FIG. 4 is an example of the first setting form.

As explained above, the first setting form refers to a screen designed for users (e.g., skilled people or experts) proficient in setting of a plurality of first setting items for the robot control device 30 and refers to a screen on which each of the plurality of first setting items can be individually set in the robot control device 30 by the teaching device 40. Therefore, in the first setting form, the user can match a motion of the robot 20 in the direct teaching with a motion desired by the user (a desirable motion). As a result, the user can easily perform more highly accurate direct teaching on the robot control device 30 by using the teaching device 40.

The screen X0 includes, for example, a region X1 (see an upper part of FIG. 4). Note that the screen X0 may include another GUI (Graphical User Interface) instead of the region X1 or may include another GUI in addition to the region X1.

The region X1 includes, for example, pulldown menus PX1 to PX5, checkboxes CX1 to CX6, input fields FX1 FX3, input fields FY1 to FY3, input fields FZ1 to FZ3, input fields TX1 to TX3, input fields TY1 to TY3, and input fields TZ1 to TZ3.

Note that the region X1 may include other GUIs instead of a part or all of the pulldown menus PX1 to PX5, the checkboxes CX1 to CX6, the input fields FX1 to FX3, the input fields FY1 to FY3, the input fields FZ1 to FZ3, the input fields TX1 to TX3, the input fields TY1 to TY3, and the input fields TZ1 to TZ3. Note that the region X1 may include other GUIs in addition to the pulldown menus PX1 to PX5, the checkboxes CX1 to CX6, the input fields FX1 to FX3, the input fields FY1 to FY3, the input fields FZ1 to FZ3, the input fields TX1 to TX3, the input fields TY1 to TY3, and the input fields TZ1 to TZ3.

### A7-2. Selection of the First High-Order File

The pulldown menu PX1 is a GUI including an input field to which the user is capable of inputting a file name. The user is capable of selecting, in the pulldown menu PX1, the first high-order file stored in the robot control device 30. The “eleventh file”, the “twelfth file”, and the “thirteenth file” are associated with the “first high-order file” as files belonging to the “first high-order file”. When a file name is input to the input field by the user, the display control section 461 displays the file name input by the user in the pulldown menu PX1. The setting control section 463 generates, in the storage region of the robot control device 30, a first high-order file having the file name input by the user and a first file belonging to the first high-order file.

When the pulldown menu PX1 is clicked (tapped) by the user (i.e., when selection of the pulldown menu PX1 is received), the display control section 461 acquires, from the robot control device 30, information indicating a list including file names of respective one or more first high-order files stored in the robot control device 30. The display control section 461 causes the display section 45 to display the list indicated by the acquired information. When a certain file name is clicked (tapped) by the user in the list (i.e., when selection of the file name is received), the display control section 461 erases the display of the list from the display section 45 and displays the file name in the input field. Note that the pulldown menu PX1 may be a GUI different from the pulldown menu if the GUI is capable of realizing these functions. In the following explanation, for convenience of the explanation, the file name displayed in the pulldown menu PX1 is referred to as “target first high-order file name” and a first high-order file having the target first high-order file name is referred to as “target first high-order file”. In the following explanation, the eleventh file belonging to the target first high-order file is referred to as “target eleventh file”.

### A7-3. Selection of the First Setting Information Indicating Effectiveness/Ineffectiveness of the Gravity Compensation

The pulldown menu PX2 is a GUI with which the user is capable of selecting the first setting information set in the first setting item of (1) described above. That is, the pulldown menu PX2 is a GUI with which the user is capable of selecting information indicating effectiveness of the gravity compensation or information indicating ineffectiveness of the gravity compensation. When the pulldown menu PX2 is clicked (tapped) by the user (i.e., when selection of the pulldown menu PX2 is received), the display control section 461 causes the display section 45 to display a list including the information indicating effectiveness of the gravity compensation and the information indicating ineffectiveness of the gravity compensation.

When the information indicating effectiveness of the gravity compensation is clicked (tapped) by the user in the list (i.e., when selection of the information is received), the display control section 461 erases the display of the list from the display section 45 and displays the information in the pulldown menu PX2. The setting control section 463 stores the information in the target eleventh file as the first setting information set in the first setting item of (1) described above. On the other hand, when the information indicating ineffectiveness of the gravity compensation is clicked (tapped) by the user in the list (i.e., when selection of the information is received), the display control section 461 erases the display of the list from the display section 45 and displays the information in the pulldown menu PX2. The setting control section 463 stores the information in the target eleventh file as the first setting information set in the first setting item of (1) described above. Consequently, the setting control section 463 sets the first setting information in the first setting item of (1) described above in the robot control device 30.

Note that the pulldown menu PX2 shown in FIG. 4 is an example of the pulldown menu PX2 in this case. That is, “0: gravity compensation OFF” shown in FIG. 4 is an example of the information indicating ineffectiveness of the gravity compensation. Note that the pulldown menu PX2 may be another GUI different from the pulldown menu if the GUI is capable of realizing these functions.

When the information indicating effectiveness of the gravity compensation is set in the first setting item of (1) described above as the first setting information, the robot control device 30 performs the gravity compensation in the force control in the direct teaching. Processing in which the robot control device 30 performs the gravity compensation may be known processing or may be processing to be developed in future. On the other hand, when the information indicating ineffectiveness of the gravity compensation is set in the first setting item of (1) described above as the first setting information, the robot control device 30 does not preform the gravity compensation in the force control in the direct teaching.

### A7-4. Selection of the Twelfth File Indicating Propriety of Translation and Rotation Concerning the Axes of the Control Point T

The pulldown menu PX3 is a GUI including an input field to which the user is capable of inputting a file name. The user is capable of selecting, in the pulldown menu PX3, the twelfth file stored in the robot control device 30. The “twelfth file” is a file that stores information explained below as the first setting information set in the first setting items of respective (3) to (26). The information is information indicating propriety of translation of the control point T in the direction along each of the X axis, the Y axis, and the Z axis in the reference coordinate system indicated by the information stored in the thirteenth file, information indicating propriety of rotation of the control point T in the direction along each of the U axis, the V axis, and the W axis in the reference coordinate system, and information indicating each of a mass coefficient, a coefficient of elasticity, and a coefficient of viscosity of force control with respect to the direction along each of the X axis, the Y axis, the Z axis, the U axis, the V axis, and the W axis. When a file name is input to the input field by the user, the display control section 461 displays the file name input by the user in the pulldown menu PX3. The setting control section 463 generates the twelfth file having the file name input by the user in the storage region as the twelfth file belonging to the target first high-order file.

When the pulldown menu PX3 is clicked (tapped) by the user (i.e., when selection of the pulldown menu PX3 is received), the display control section 461 acquires, from the robot control device 30, information indicating a list including file names of respective one or more twelfth files belonging to the target first high-order file. The display control section 461 causes the display section 45 to display the list indicated by the acquired information. When a certain file name is clicked (tapped) by the user in the list (i.e., when selection of the file name is received), the display control section 461 erases the display of the list from the display section 45 and displays the file name in the input field.

Note that the pulldown menu PX3 may be another GUI different from the pulldown menu if the GUI is capable of realizing these functions. In the following explanation, for convenience of the explanation, the file name displayed in the pulldown menu PX3 is referred to as “target twelfth file name” and the twelfth file name having the target twelfth file name is referred to as “target twelfth file”.

### A7-5. Selection of the Thirteenth File Indicating the Reference Coordinate System

The pulldown menu PX4 is a GUI including an input field to which the user is capable of inputting a file name. The user is capable of selecting, in the pulldown menu PX4, the thirteenth file stored in the robot control device 30. The “thirteenth file” is a file that stores, as the first setting information set in the first setting item of (2) explained above, information indicating a coordinate system selected by the user as the reference coordinate system. When a file name is input to the input field by the user, the display control section 461 displays the file name input by the user in the pulldown menu PX4. The setting control section 463 generates the thirteenth file having the file name input by the user in the storage region as the thirteenth file belonging to the target first high-order file.

When the pulldown menu PX4 is clicked (tapped) by the user (i.e., when selection of the pulldown menu PX4 is received), the display control section 461 acquires, from the robot control device 30, information indicating a list including file names of respective one or more thirteenth files belonging to the target first high-order file. The display control section 461 causes the display section 45 to display the list indicated by the acquired information. When a certain file name is clicked (tapped) by the user in the list (i.e., when selection of the file name is received), the display control section 461 erases the display of the list from the display section 45 and displays the file name in the input field.

Note that the pulldown menu PX4 may be another GUI different from the pulldown menu if the GUI is capable of realizing these functions. In the following explanation, for convenience of explanation, a file name displayed in the pulldown menu PX4 is referred to as “target thirteenth file name” and the thirteenth file having the target thirteenth file name is referred to as “target thirteenth file”.

### A7-6. Selection of the First Setting Information Indicating the Reference Coordinate System

The pulldown menu PX5 is a GUI with which the user is capable of selecting the first setting information set in the first setting item of (2) described above. That is, the pulldown menu PX5 is a GUI with which the user is capable of selecting coordinate system information indicating a desired coordinate system that the user desires to set as the reference coordinate system in coordinate system information indicating respective one or more coordinate systems stored (set or registered) in the robot control device 30.

When the pulldown menu PX5 is clicked (tapped) by the user (e.g., selection of the pulldown menu PX5 is received), the display control section 461 acquires, from the robot control device 30, information indicating a list including one or more kinds of coordinate system information stored in the storage region of the robot control device 30. The display control section 461 causes the display section 45 to display the list indicated by the acquired information. When certain coordinate system information is clicked (tapped) by the user in the list (i.e., when selection of the coordinate system information is received), the display control section 461 erases the display of the list from the display section 45 and displays the coordinate system information in the pulldown menu PX5. The setting control section 463 stores the coordinate system information in the target thirteenth file as the first setting information set in the first setting item of (2) described above. Consequently, the setting control section 463 sets the first setting information in the first setting item of (2) describe above in the robot control device 30.

Note that the pulldown menu PX5 may be another GUI different from the pulldown menu if the GUI is capable of realizing these functions. In the following explanation, the “reference coordinate system” means a coordinate system indicated by the coordinate system information displayed in the pulldown menu PX5.

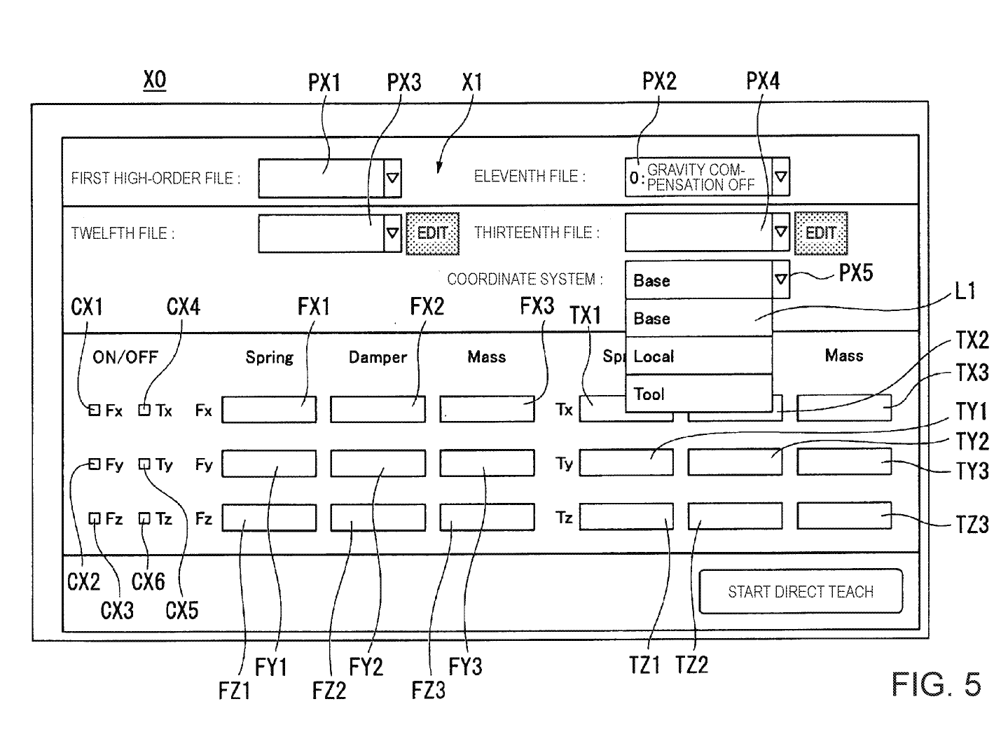

FIG. 5 is a diagram showing an example of the screen X0 displayed when the pulldown menu PX5 on the screen X0 shown in FIG. 4 is clicked (tapped) by the user. As explained above, in this case (i.e., when selection of the pulldown menu PX5 is received), for example, the display control section 461 causes the display section 45 to display a list including coordinate system information indicating respective one or more coordinate systems selectable as the reference coordinate system. A list L1 shown in FIG. 5 is an example of the list. In the example shown in FIG. 5, coordinate systems respectively indicated by “Base”, “Local”, and “Tool” are displayed in the list L1.

In this example, the “Base” is coordinate system information indicating a coordinate system based on the supporting table B of the robot 20, that is, a robot coordinate system. In this example, the “Local” is coordinate system information indicating a three-dimensional local coordinate system set in any position by the user. In this example, the “Tool” is coordinate system information indicating a three-dimensional local coordinate system set in any position of a tool provided in the robot 20 by the user and is, for example, coordinate system information indicating the control point coordinate system explained above.

The pulldown menu PX5 shown in FIG. 4 is an example of the pulldown menu PX5 displayed when the “Base” is clicked (tapped) by the user in the list L1 (i.e., when selection of the “Base” is received). Note that, in the list L1, coordinate system information indicating another coordinate system may be displayed instead of apart or all of the “Base”, the “Local”, and the “Tool” or coordinate system information indicating another coordinate system may be displayed in addition to the “Base”, the “Local”, and the “Tool”. In the list L1, two or more kinds of coordinate system information (in the example shown in FIG. 5, the “Local”) indicating three-dimensional local coordinate systems set in any positions by the user may be displayed. In this case, the two or more kinds of coordinate system information indicating the respective three-dimensional coordinate systems displayed in the list L1 are kinds of information distinguishable from one another. In the list L1, two or more kinds of coordinate system information (in the example shown in FIG. 5, the “Tool”) indicating three-dimensional local coordinate systems set in any positions of a tool provided in the robot 20 by the user may be displayed. In this case, the two or more kinds of coordinate system information indicating the respective three-dimensional local coordinate systems displayed in the list L1 are kinds of information distinguishable from one another.

A7-7. Selection of the First Setting Information Indicating Propriety of Translation of the Control Point T in the Direction along the X Axis

Referring back to FIG. 4, the checkbox CX1 is a GUI with which the user is capable of selecting the first setting information set in the first setting item of (3) described above. That is, the checkbox CX1 is a GUI with which the user is capable of selecting propriety of translation of the control point T in the direction along the X axis in the reference coordinate system. When the checkbox CX1 is checked, in the force control, the moving direction of the robot 20 can include the direction along the X axis as a direction component.

When the checkbox CX1 is clicked (tapped) by the user (i.e., when selection of the checkbox CX1 is received) in a state in which information indicating that the checkbox CX1 is clicked is not displayed in the checkbox CX1, the display control section 461 displays, in the checkbox CX1, information indicating that the checkbox CX1 is clicked. On the other hand, when the checkbox CX1 is clicked (tapped) by the user (i.e., when selection of the checkbox CX1 is received) in a state in which information indicating that the checkbox CX1 is clicked is displayed in the checkbox CX1, the display control section 461 deletes, from the checkbox CX1, the information indicating that the checkbox CX1 is clicked.

In the state in which the information indicating that the checkbox CX1 is clicked is not displayed in the checkbox CX1, the setting control section 463 stores, in the target twelfth file, as the first setting information set in the first setting item of (3) described above, information indicating non-permission of translation of the control point T in the direction along the X axis in the reference coordinate system. On the other hand, in the state in which the information indicating that the checkbox CX1 is clicked is displayed in the checkbox CX1, the setting control section 463 stores, in the target twelfth file, as the first setting information set in the first setting item of (3) described above, information indicating permission of translation of the control point T in the direction along the X axis in the reference coordinate system. Consequently, the setting control section 463 sets the first setting information in the first setting item of (3) described above in the robot control device 30. Note that the checkbox CX1 may be another GUI different from the pulldown menu if the GUI is capable of realizing these functions.

A7-8. Selection of the First Setting Information Indicating Propriety of Translation of the Control Point T in the Direction along the Y Axis

The checkbox CX2 is a GUI with which the user is capable of selecting the first setting information set in the first setting item of (4) described above. That is, the checkbox CX2 is a GUI with which the user is capable of selecting propriety of translation of the control point T in the direction along the Y axis in the reference coordinate system. When the checkbox CX2 is checked, in the force control, the moving direction of the robot 20 can include the direction along the Y axis as a direction component.

When the checkbox CX2 is clicked (tapped) by the user (i.e., when selection of the checkbox CX2 is received) in a state in which information indicating that the checkbox CX2 is clicked is not displayed in the checkbox CX2, the display control section 461 displays, in the checkbox CX2, information indicating that the checkbox CX2 is clicked. On the other hand, when the checkbox CX2 is clicked (tapped) by the user (i.e., when selection of the checkbox CX2 is received) in a state in which information indicating that the checkbox CX2 is clicked is displayed in the checkbox CX2, the display control section 461 deletes, from the checkbox CX2, the information indicating that the checkbox CX2 is clicked.

In the state in which the information indicating that the checkbox CX2 is clicked is not displayed in the checkbox CX2, the setting control section 463 stores, in the target twelfth file, as the first setting information set in the first setting item of (4) described above, information indicating non-permission of translation of the control point T in the direction along the Y axis in the reference coordinate system. On the other hand, in the state in which the information indicating that the checkbox CX2 is clicked is displayed in the checkbox CX2, the setting control section 463 stores, in the target twelfth file, as the first setting information set in the first setting item of (4) described above, information indicating permission of translation of the control point T in the direction along the Y axis in the reference coordinate system. Consequently, the setting control section 463 sets the first setting information in the first setting item of (4) described above in the robot control device 30. Note that the checkbox CX2 may be another GUI different from the pulldown menu if the GUI is capable of realizing these functions.

A7-9. Selection of the First Setting Information Indicating Propriety of Translation of the Control Point T in the Direction along the Z Axis

The checkbox CX3 is a GUI with which the user is capable of selecting the first setting information set in the first setting item of (5) described above. That is, the checkbox CX3 is a GUI with which the user is capable of selecting propriety of translation of the control point T in the direction along the Z axis in the reference coordinate system. When the checkbox CX3 is checked, in the force control, the moving direction of the robot 20 can include the direction along the Z axis as a direction component.

When the checkbox CX3 is clicked (tapped) by the user (i.e., when selection of the checkbox CX3 is received) in a state in which information indicating that the checkbox CX3 is clicked is not displayed in the checkbox CX3, the display control section 461 displays, in the checkbox CX3, information indicating that the checkbox CX3 is clicked. On the other hand, when the checkbox CX3 is clicked (tapped) by the user (i.e., when selection of the checkbox CX3 is received) in a state in which information indicating that the checkbox CX3 is clicked is displayed in the checkbox CX3, the display control section 461 deletes, from the checkbox CX3, the information indicating that the checkbox CX3 is clicked.

In the state in which the information indicating that the checkbox CX3 is clicked is not displayed in the checkbox CX3, the setting control section 463 stores, in the target twelfth file, as the first setting information set in the first setting item of (5) described above, information indicating non-permission of translation of the control point T in the direction along the Z axis in the reference coordinate system. On the other hand, in the state in which the information indicating that the checkbox CX3 is clicked is displayed in the checkbox CX3, the setting control section 463 stores, in the target twelfth file, as the first setting information set in the first setting item of (5) described above, information indicating permission of translation of the control point T in the direction along the Z axis in the reference coordinate system. Consequently, the setting control section 463 sets the first setting information in the first setting item of (5) described above in the robot control device 30. Note that the checkbox CX3 may be another GUI different from the pulldown menu if the GUI is capable of realizing these functions.

A7-10. Selection of the First Setting Information Indicating Propriety of Rotation of the Control Point T in the Direction along the U Axis

The checkbox CX4 is a GUI with which the user is capable of selecting the first setting information set in the first setting item of (6) described above. That is, the checkbox CX4 is a GUI with which the user is capable of selecting propriety of rotation of the control point T in the direction along the U axis in the reference coordinate system. When the checkbox CX4 is checked, in the force control, the rotating direction of the robot 20 can include the direction along the U axis as a direction component. Note that, in this specification, both of the moving direction of translation or the like and the rotating direction are collectively referred to as “moving direction” in a broad sense.

When the checkbox CX4 is clicked (tapped) by the user (i.e., when selection of the checkbox CX4 is received) in a state in which information indicating that the checkbox CX4 is clicked is not displayed in the checkbox CX4, the display control section 461 displays, in the checkbox CX4, information indicating that the checkbox CX4 is clicked. On the other hand, when the checkbox CX4 is clicked (tapped) by the user (i.e., when selection of the checkbox CX4 is received) in a state in which information indicating that the checkbox CX4 is clicked is displayed in the checkbox CX4, the display control section 461 deletes, from the checkbox CX4, the information indicating that the checkbox CX4 is clicked.

In the state in which the information indicating that the checkbox CX4 is clicked is not displayed in the checkbox CX4, the setting control section 463 stores, in the target twelfth file, as the first setting information set in the first setting item of (6) described above, information indicating non-permission of rotation of the control point T in the direction along the U axis in the reference coordinate system. On the other hand, in the state in which the information indicating that the checkbox CX4 is clicked is displayed in the checkbox CX4, the setting control section 463 stores, in the target twelfth file, as the first setting information set in the first setting item of (6) described above, information indicating permission of rotation of the control point T in the direction along the U axis in the reference coordinate system. Consequently, the setting control section 463 sets the first setting information in the first setting item of (6) described above in the robot control device 30. Note that the checkbox CX4 may be another GUI different from the pulldown menu if the GUI is capable of realizing these functions.

A7-11. Selection of the First Setting Information Indicating Propriety of Rotation of the Control Point T in the Direction along the V Axis

The checkbox CX5 is a GUI with which the user is capable of selecting the first setting information set in the first setting item of (7) described above. That is, the checkbox CX5 is a GUI with which the user is capable of selecting propriety of rotation of the control point T in the direction along the V axis in the reference coordinate system. When the checkbox CX5 is checked, in the force control, the rotating direction of the robot 20 can include the direction along the V axis as a direction component.

When the checkbox CX5 is clicked (tapped) by the user (i.e., when selection of the checkbox CX5 is received) in a state in which information indicating that the checkbox CX5 is clicked is not displayed in the checkbox CX5, the display control section 461 displays, in the checkbox CX5, information indicating that the checkbox CX5 is clicked. On the other hand, when the checkbox CX5 is clicked (tapped) by the user (i.e., when selection of the checkbox CX5 is received) in a state in which information indicating that the checkbox CX5 is clicked is displayed in the checkbox CX5, the display control section 461 deletes, from the checkbox CX5, the information indicating that the checkbox CX5 is clicked.

In the state in which the information indicating that the checkbox CX5 is clicked is not displayed in the checkbox CX5, the setting control section 463 stores, in the target twelfth file, as the first setting information set in the first setting item of (7) described above, information indicating non-permission of rotation of the control point T in the direction along the V axis in the reference coordinate system. On the other hand, in the state in which the information indicating that the checkbox CX5 is clicked is displayed in the checkbox CX5, the setting control section 463 stores, in the target twelfth file, as the first setting information set in the first setting item of (7) described above, information indicating permission of rotation of the control point T in the direction along the V axis in the reference coordinate system. Consequently, the setting control section 463 sets the first setting information in the first setting item of (7) described above in the robot control device 30. Note that the checkbox CX5 may be another GUI different from the pulldown menu if the GUI is capable of realizing these functions.

A7-12. Selection of the First Setting Information Indicating Propriety of Rotation of the Control Point T in the Direction along the W Axis

The checkbox CX6 is a GUI with which the user is capable of selecting the first setting information set in the first setting item of (8) described above. That is, the checkbox CX6 is a GUI with which the user is capable of selecting propriety of rotation of the control point T in the direction along the W axis in the reference coordinate system. When the checkbox CX6 is checked, in the force control, the rotating direction of the robot 20 can include the direction along the W axis as a direction component.

When the checkbox CX6 is clicked (tapped) by the user (i.e., when selection of the checkbox CX6 is received) in a state in which information indicating that the checkbox CX6 is clicked is not displayed in the checkbox CX6, the display control section 461 displays, in the checkbox CX6, information indicating that the checkbox CX6 is clicked. On the other hand, when the checkbox CX6 is clicked (tapped) by the user (i.e., when selection of the checkbox CX6 is received) in a state in which information indicating that the checkbox CX6 is clicked is displayed in the checkbox CX6, the display control section 461 deletes, from the checkbox CX6, the information indicating that the checkbox CX6 is clicked.

In the state in which the information indicating that the checkbox CX6 is clicked is not displayed in the checkbox CX6, the setting control section 463 stores, in the target twelfth file, as the first setting information set in the first setting item of (8) described above, information indicating non-permission of rotation of the control point T in the direction along the W axis in the reference coordinate system. On the other hand, in the state in which the information indicating that the checkbox CX6 is clicked is displayed in the checkbox CX6, the setting control section 463 stores, in the target twelfth file, as the first setting information set in the first setting item of (8) described above, information indicating permission of rotation of the control point T in the direction along the W axis in the reference coordinate system. Consequently, the setting control section 463 sets the first setting information in the first setting item of (8) described above in the robot control device 30. Note that the checkbox CX6 may be another GUI different from the pulldown menu if the GUI is capable of realizing these functions.

A7-13. Input of the First Setting Information Indicating Values of the Coefficients of the Force Control with Respect to the Direction along the X Axis

The input field FX1 is a GUI to which the user is capable of inputting the first setting information set in the first setting item of (9) described above. That is, the input field FX1 is a GUI to which the user is capable of inputting a value of the mass coefficient of the force control with respect to the direction along the X axis in the reference coordinate system. When the value is input to the input field FX1 by the user, the display control section 461 displays the value in the input field FX1. The setting control section 463 stores the value in the target twelfth file as the first setting information set in the first setting item of (9) described above. Consequently, the setting control section 463 sets the first setting information in the first setting item of (9) described above in the robot control device 30. Note that the input field FX1 may be another GUI different from the input field if the GUI is capable of realizing these functions.

The input field FX2 is a GUI to which the user is capable of inputting the first setting information set in the first setting item of (10) described above. That is, the input field FX2 is a GUI to which the user is capable of inputting a value of the coefficient of elasticity of the force control with respect to the direction along the X axis in the reference coordinate system. When the value is input to the input field FX2 by the user, the display control section 461 displays the value in the input field FX2. The setting control section 463 stores the value in the target twelfth file as the first setting information set in the first setting item of (10) described above. Consequently, the setting control section 463 sets the first setting information in the first setting item of (10) described above in the robot control device 30. Note that the input field FX2 may be another GUI different from the input field if the GUI is capable of realizing these functions.

The input field FX3 is a GUI to which the user is capable of inputting the first setting information set in the first setting item of (11) described above. That is, the input field FX3 is a GUI to which the user is capable of inputting a value of the coefficient of viscosity of the force control with respect to the direction along the X axis in the reference coordinate system. When the value is input to the input field FX3 by the user, the display control section 461 displays the value in the input field FX3. The setting control section 463 stores the value in the target twelfth file as the first setting information set in the first setting item of (11) described above. Consequently, the setting control section 463 sets the first setting information in the first setting item of (11) described above in the robot control device 30. Note that the input field FX3 may be another GUI different from the input field if the GUI is capable of realizing these functions.

A7-14. Input of the First Setting Information Indicating Values of the Coefficients of the Force Control with Respect to the Direction along the Y Axis

The input field FY1 is a GUI to which the user is capable of inputting the first setting information set in the first setting item of (12) described above. That is, the input field FY1 is a GUI to which the user is capable of inputting a value of the mass coefficient of the force control with respect to the direction along the Y axis in the reference coordinate system. When the value is input to the input field FY1 by the user, the display control section 461 displays the value in the input field FY1. The setting control section 463 stores the value in the target twelfth file as the first setting information set in the first setting item of (12) described above. Consequently, the setting control section 463 sets the first setting information in the first setting item of (12) described above in the robot control device 30. Note that the input field FY1 may be another GUI different from the input field if the GUI is capable of realizing these functions.

The input field FY2 is a GUI to which the user is capable of inputting the first setting information set in the first setting item of (13) described above. That is, the input field FY2 is a GUI to which the user is capable of inputting a value of the coefficient of elasticity of the force control with respect to the direction along the Y axis in the reference coordinate system. When the value is input to the input field FY2 by the user, the display control section 461 displays the value in the input field FY2. The setting control section 463 stores the value in the target twelfth file as the first setting information set in the first setting item of (13) described above. Consequently, the setting control section 463 sets the first setting information in the first setting item of (13) described above in the robot control device 30. Note that the input field FY2 may be another GUI different from the input field if the GUI is capable of realizing these functions.

The input field FY3 is a GUI to which the user is capable of inputting the first setting information set in the first setting item of (14) described above. That is, the input field FY3 is a GUI to which the user is capable of inputting a value of the coefficient of viscosity of the force control with respect to the direction along the Y axis in the reference coordinate system. When the value is input to the input field FY3 by the user, the display control section 461 displays the value in the input field FY3. The setting control section 463 stores the value in the target twelfth file as the first setting information set in the first setting item of (14) described above. Consequently, the setting control section 463 sets the first setting information in the first setting item of (14) described above in the robot control device 30. Note that the input field FY3 may be another GUI different from the input field if the GUI is capable of realizing these functions.

A7-15. Input of the First Setting Information Indicating the Coefficients of the Force Control with Respect to the Direction along the Z Axis

The input field FZ1 is a GUI to which the user is capable of inputting the first setting information set in the first setting item of (15) described above. That is, the input field FZ1 is a GUI to which the user is capable of inputting a value of the mass coefficient of the force control with respect to the direction along the Z axis in the reference coordinate system. When the value is input to the input field FZ1 by the user, the display control section 461 displays the value in the input field FZ1. The setting control section 463 stores the value in the target twelfth file as the first setting information set in the first setting item of (15) described above. Consequently, the setting control section 463 sets the first setting information in the first setting item of (15) described above in the robot control device 30. Note that the input field FZ1 may be another GUI different from the input field if the GUI is capable of realizing these functions.

The input field FZ2 is a GUI to which the user is capable of inputting the first setting information set in the first setting item of (16) described above. That is, the input field FZ2 is a GUI to which the user is capable of inputting a value of the coefficient of elasticity of the force control with respect to the direction along the Z axis in the reference coordinate system. When the value is input to the input field FZ2 by the user, the display control section 461 displays the value in the input field FZ2. The setting control section 463 stores the value in the target twelfth file as the first setting information set in the first setting item of (16) described above. Consequently, the setting control section 463 sets the first setting information in the first setting item of (16) described above in the robot control device 30. Note that the input field FZ2 may be another GUI different from the input field if the GUI is capable of realizing these functions.

The input field FZ3 is a GUI to which the user is capable of inputting the first setting information set in the first setting item of (17) described above. That is, the input field FZ3 is a GUI to which the user is capable of inputting a value of the coefficient of viscosity of the force control with respect to the direction along the Z axis in the reference coordinate system. When the value is input to the input field FZ3 by the user, the display control section 461 displays the value in the input field FZ3. The setting control section 463 stores the value in the target twelfth file as the first setting information set in the first setting item of (17) described above. Consequently, the setting control section 463 sets the first setting information in the first setting item of (17) described above in the robot control device 30. Note that the input field FZ3 may be another GUI different from the input field if the GUI is capable of realizing these functions.

A7-16. Input of the First Setting Information Indicating Values of the Coefficients of the Force Control with Respect to the Direction along the U Axis

The input field TX1 is a GUI to which the user is capable of inputting the first setting information set in the first setting item of (18) described above. That is, the input field TX1 is a GUI to which the user is capable of inputting a value of the mass coefficient of the force control with respect to the direction along the U axis in the reference coordinate system. When the value is input to the input field TX1 by the user, the display control section 461 displays the value in the input field TX1. The setting control section 463 stores the value in the target twelfth file as the first setting information set in the first setting item of (18) described above. Consequently, the setting control section 463 sets the first setting information in the first setting item of (18) described above in the robot control device 30. Note that the input field TX1 may be another GUI different from the input field if the GUI is capable of realizing these functions.

The input field TX2 is a GUI to which the user is capable of inputting the first setting information set in the first setting item of (19) described above. That is, the input field TX2 is a GUI to which the user is capable of inputting a value of the coefficient of elasticity of the force control with respect to the direction along the U axis in the reference coordinate system. When the value is input to the input field TX2 by the user, the display control section 461 displays the value in the input field TX2. The setting control section 463 stores the value in the target twelfth file as the first setting information set in the first setting item of (19) described above. Consequently, the setting control section 463 sets the first setting information in the first setting item of (19) described above in the robot control device 30. Note that the input field TX2 may be another GUI different from the input field if the GUI is capable of realizing these functions.

The input field TX3 is a GUI to which the user is capable of inputting the first setting information set in the first setting item of (20) described above. That is, the input field TX3 is a GUI to which the user is capable of inputting a value of the coefficient of viscosity of the force control with respect to the direction along the U axis in the reference coordinate system. When the value is input to the input field TX3 by the user, the display control section 461 displays the value in the input field TX3. The setting control section 463 stores the value in the target twelfth file as the first setting information set in the first setting item of (20) described above. Consequently, the setting control section 463 sets the first setting information in the first setting item of (20) described above in the robot control device 30. Note that the input field TX3 may be another GUI different from the input field if the GUI is capable of realizing these functions.

A7-17. Input of the First Setting Information Indicating Values of the Coefficients of the Force Control with Respect to the Direction along the V Axis

The input field TY1 is a GUI to which the user is capable of inputting the first setting information set in the first setting item of (21) described above. That is, the input field TY1 is a GUI to which the user is capable of inputting a value of the mass coefficient of the force control with respect to the direction along the V axis in the reference coordinate system. When the value is input to the input field TY1 by the user, the display control section 461 displays the value in the input field TY1. The setting control section 463 stores the value in the target twelfth file as the first setting information set in the first setting item of (21) described above. Consequently, the setting control section 463 sets the first setting information in the first setting item of (21) described above in the robot control device 30. Note that the input field TY1 may be another GUI different from the input field if the GUI is capable of realizing these functions.

The input field TY2 is a GUI to which the user is capable of inputting the first setting information set in the first setting item of (22) described above. That is, the input field TY2 is a GUI to which the user is capable of inputting a value of the coefficient of elasticity of the force control with respect to the direction along the V axis in the reference coordinate system. When the value is input to the input field TY2 by the user, the display control section 461 displays the value in the input field TY2. The setting control section 463 stores the value in the target twelfth file as the first setting information set in the first setting item of (22) described above. Consequently, the setting control section 463 sets the first setting information in the first setting item of (22) described above in the robot control device 30. Note that the input field TY2 may be another GUI different from the input field if the GUI is capable of realizing these functions.

The input field TY3 is a GUI to which the user is capable of inputting the first setting information set in the first setting item of (23) described above. That is, the input field TY3 is a GUI to which the user is capable of inputting a value of the coefficient of viscosity of the force control with respect to the direction along the V axis in the reference coordinate system. When the value is input to the input field TY3 by the user, the display control section 461 displays the value in the input field TY3. The setting control section 463 stores the value in the target twelfth file as the first setting information set in the first setting item of (23) described above. Consequently, the setting control section 463 sets the first setting information in the first setting item of (23) described above in the robot control device 30. Note that the input field TY3 may be another GUI different from the input field if the GUI is capable of realizing these functions.

A7-18. Input of the First Setting Information Indicating Values of the Coefficients of the Force Control with Respect to the Direction along the W Axis

The input field TZ1 is a GUI to which the user is capable of inputting the first setting information set in the first setting item of (24) described above. That is, the input field TZ1 is a GUI to which the user is capable of inputting a value of the mass coefficient of the force control with respect to the direction along the W axis in the reference coordinate system. When the value is input to the input field TZ1 by the user, the display control section 461 displays the value in the input field TZ1. The setting control section 463 stores the value in the target twelfth file as the first setting information set in the first setting item of (24) described above. Consequently, the setting control section 463 sets the first setting information in the first setting item of (24) described above in the robot control device 30. Note that the input field TZ1 may be another GUI different from the input field if the GUI is capable of realizing these functions.

The input field TZ2 is a GUI to which the user is capable of inputting the first setting information set in the first setting item of (25) described above. That is, the input field TZ2 is a GUI to which the user is capable of inputting a value of the coefficient of elasticity of the force control with respect to the direction along the W axis in the reference coordinate system. When the value is input to the input field TZ2 by the user, the display control section 461 displays the value in the input field TZ2. The setting control section 463 stores the value in the target twelfth file as the first setting information set in the first setting item of (25) described above. Consequently, the setting control section 463 sets the first setting information in the first setting item of (25) described above in the robot control device 30. Note that the input field TZ2 may be another GUI different from the input field if the GUI is capable of realizing these functions.

The input field TZ3 is a GUI to which the user is capable of inputting the first setting information set in the first setting item of (26) described above. That is, the input field TZ3 is a GUI to which the user is capable of inputting a value of the coefficient of viscosity of the force control with respect to the direction along the W axis in the reference coordinate system. When the value is input to the input field TZ3 by the user, the display control section 461 displays the value in the input field TZ3. The setting control section 463 stores the value in the target twelfth file as the first setting information set in the first setting item of (26) described above. Consequently, the setting control section 463 sets the first setting information in the first setting item of (26) described above in the robot control device 30. Note that the input field TZ3 may be another GUI different from the input field if the GUI is capable of realizing these functions.

As explained above, the first setting items include the mass coefficient, the coefficient of elasticity, and the coefficient of viscosity used in the force control. Therefore, the user can set the mass coefficient, the coefficient of elasticity, and the coefficient of viscosity serving as the first setting items to desirable values and set the characteristics of the robot in the force control to characteristics desired by the user.

### A7-19. Effects of the First Setting Form

By causing the display section 45 to display the screen X0 (i.e., the first setting form) explained above, the teaching device 40 can individually set the respective plurality of first setting items related to the force control in the direct teaching among the plurality of setting items that the teaching device 40 is capable of setting in the robot control device 30. Consequently, the user can match the motion of the robot 20 in the direct teaching with a desired motion (a preferred motion). As a result, by using the teaching device 40, the user can perform more highly accurate direct teaching on the robot control device 30 such that the performance of the robot can be sufficiently exhibited.

### A8. Processing Performed by the Teaching Device in the Second Operation Mode

### A8-1. Initial Screen of the Second Setting Mode

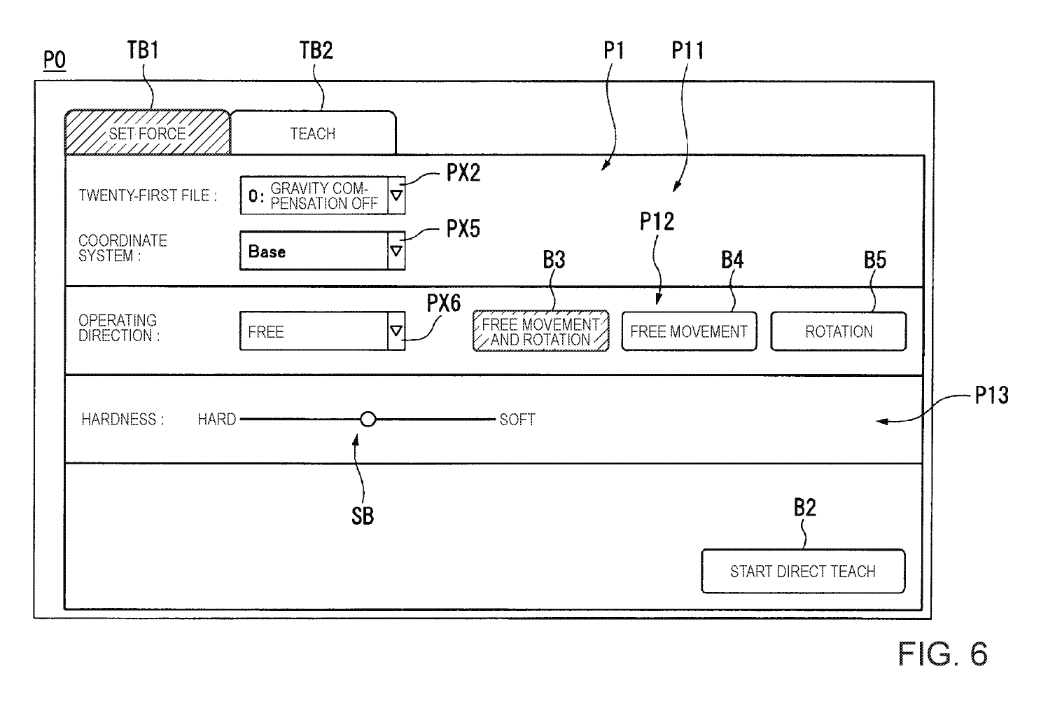

FIG. 6 is a diagram showing an example of the second setting form that the teaching device 40 causes the display section 45 to display in the second operation mode. A screen P0 shown in FIG. 6 is an example of the second setting form. An operation mode of the teaching device 40 is selected by the user in a GUI of a selection screen displayed prior to the display of FIG. 4 and the display of FIG. 6 and is input to the teaching device 40. Note that, in this embodiment, the operation mode of the teaching device 40 is selected, whereby the first setting form and the second setting form are selectively displayed. However, the first setting form and the second setting form may be simultaneously displayed in one screen. Processing performed by the teaching device 40 in the second operation mode is explained below with reference to FIG. 6.

As explained above, the second setting form refers to a screen designed for users (e.g., novices or beginners) nonproficient in the setting of the plurality of first setting items for the robot control device 30 and refers to a screen on which at least a part (at least two) of the plurality of first setting items can be collectively set in the robot control device 30 as one second setting item by the teaching device 40. Therefore, in the second setting form, the user can easily perform the setting of the plurality of first setting items compared with when the first setting form is used.

In the second operation mode, the teaching device 40 controls the robot control device 30 without receiving operation from the user and generates a second high-order file in the storage region of the robot control device 30. The “second high-order file” is the first high-order file exclusive for the second operation mode. In the second operation mode, the teaching device 40 controls the robot control device 30 without receiving operation from the user and generates, in the storage region, each of a twenty-first file, a twenty-second file, and a twenty-third file, which are three kinds of files belonging to the second high-order file. The “twenty-first file” is the eleventh file exclusive for the second operation mode. The “twenty-second file” is the twelfth file exclusive for the second operation mode. The “twenty-third file” is the thirteenth file exclusive for the second operation mode.

Note that apart or all of the second high-order file, the twenty-first file, the twenty-second file, and the twenty-third file may not be exclusive for the second operation mode. When the second high-order file is not exclusive for the second operation mode, for example, the second high-order file is generated in the storage region of the robot control device 30 by a GUI having the same functions as the functions of the pulldown menu PX1 in the first setting form. When the twenty-first file is not exclusive for the second operation mode, the twenty-first file is generated in the storage region of the robot control device 30 by a GUI that generates the twenty-first file. When the twenty-second file is not exclusive for the second operation mode, for example, the twenty-second file is generated in the storage region of the robot control device 30 by a GUI having the same functions as the functions of the pulldown menu PX3 in the first setting form. When the twenty-third file is not exclusive for the second operation mode, for example, the twenty-third file is generated in the storage region of the robot control device 30 by a GUI having the same functions as the functions of the pulldown menu PX4 in the first setting form.

The screen P0 shown in FIG. 6 includes a tab TB1, a tab TB2, a region P1, and a button B2. Note that the screen P0 may include other GUIs instead of a part or all of the tab TB1, the tab TB2, the region P1, and the button B2. The screen P0 may include other GUIs in addition to the tab TB1, the tab TB2, the region P1, and the button B2.

Each of the tab TB1 and the tab TB2 is a GUI that switches a GUI displayed in the region P1 to a GUI corresponding to the tab. When either one of the tabs TB1 and TB2 is clicked (tapped) by the user, the display control section 461 switches the GUI displayed in the region P1 to a GUI corresponding to the tab clicked (tapped) by the user. That is, the region P1 is a region where a GUI corresponding to a tab clicked by the user is displayed. Note that, in the example shown in FIG. 6, these tabs are the two tabs, that is, the tab TB1 and the tab TB2. However, one tab or three or more tabs maybe included in the screen P0.

### A8-2. Initial Screen for Force Setting

The tab TB1 “force setting” is a tab for displaying, in the region P1, a GUI for setting the second setting item and a GUI for setting each of the plurality of first setting items not set by the second setting item among the twenty-six first setting items explained above.

When the tab TB1 is clicked (tapped) by the user (i.e., when selection of the tab TB1 is received), the display control section 461 displays, for example, each of a region P11, a region P12, and a region P13 in the region P1. The region P1 shown in FIG. 6 is an example of the region P1 displayed when the tab TB1 is clicked by the user. Note that, in this case, the display control section 461 may be configured to display other GUIs in the region P1 instead of a part or all of the region P11, the region P12, and the region P13 or may be configured to display other GUIs in the region P1 in addition to the region P11, the region P12, and the region P13.

The region P11 (see an upper part of FIG. 6) includes the pulldown menu PX2 and the pulldown menu PX5 explained above. The pulldown menu PX2 is a GUI with which the user is capable of selecting the first setting information set in the first setting item of (1) described above, that is, the information indicating effectiveness of the gravity compensation or the information indicating ineffectiveness of the gravity compensation. The pulldown menu PX5 is a GUI with which the user is capable of selecting the first setting information set in the first setting item of (2) described above, that is, coordinate system information indicating a desired coordinate system that the user desires to set as the reference coordinate system among the coordinate system information indicating the respective one or more coordinate systems stored in the robot control device 30.

Note that the region P11 may include other GUIs instead of either one or both of the pulldown menu PX2 and the pulldown menu PX5 or may include other GUIs in addition to the pulldown menu PX2 and the pulldown menu PX5.

The pulldown menu PX2 included in the region P11 has the same functions as the functions of the pulldown menu PX2 explained with reference to FIG. 4. When the information indicating effectiveness of the gravity compensation is displayed in the pulldown menu PX2 included in the region P11, the setting control section 463 stores the information in the twenty-first file. On the other hand, when the information indicating ineffectiveness of the gravity compensation is displayed in the pulldown menu PX2, the control setting section 463 stores the information in the twenty-first file. Consequently, in the second setting form, the setting control section 463 sets the first setting item of (1) described above in the robot control device 30.

The pulldown menu PX5 included in the region P11 has the same functions as the functions of the pulldown menu PX5 explained with reference to FIG. 4. When the coordinate system information indicating the coordinate system selected by the user as the reference coordinate system is displayed in the pulldown menu PX5 included in the region P11, the setting control section 463 stores the information in the twenty-third file. Consequently, in the second setting form, the setting control section 463 sets the first setting item of (2) described above, that is, the reference coordinate system in the robot control device 30.

### A8-3. Selection of a Motion Form

The region P12 (see a middle part of FIG. 6) includes a pulldown menu PX6, a button B3, a button B4, and a button B5. Note that the region P12 may include other GUIs instead of a part or all of the pulldown menu PX6, the button B3, the button B4, and the button B5 or may include other GUIs in addition to the pulldown menu PX6, the button B3, the button B4, and the button B5.

In the second setting form, the user can select a motion form, which is a form of a motion of the control point T by the force control in the direct teaching, out of predetermine one or more motion forms. The predetermined one or more motion forms include, for example, a “linear motion form”, a “planar motion form”, a “rotational motion form”, a “custom motion form”, and a “free motion form”. Note that, in this specification, a selected motion form is also described as “setting value”. That is, the “setting value” is not limited to a scalar quantity.

Note that the motion forms of the control point T may include other motion forms instead of a part or all of the linear motion form, the planar motion form, the rotational motion form, the custom motion form, and the free motion form or may include other motion forms in addition to the linear motion form, the planar motion form, the rotational motion form, the custom motion form.

A “linear motion” of the control point T refers to translation of the control point T in a direction along any one axis among the X axis, the Y axis, and the Z axis in the reference coordinate system. That is, the “linear motion form” of the control point T refers to a motion form in which the control point T performs the linear motion.

A “planar motion” of the control point T refers to translation of the control point T in a direction along a plane defined by any two axes among the X axis, the Y axis, and the Z axis. That is, the “planar motion form” of the control point T refers to a motion form in which the control point T performs the planar motion.

A “rotational motion” of the control point T refers to rotation of the control point T in a direction along any one axis among the U axis, the V axis, and the W axis in the reference coordinate system. That is, the “rotational motion form” of the control point T is a motion form in which the control point T performs the rotational motion.

A “custom motion” of the control point T refers to a motion (a motion including at least one of a translational motion and a rotational motion) of the control point T in directions along respective one or more axes selected by the user among the X axis, the Y axis, the Z axis, the U axis, the V axis, and the W axis. That is, the “custom motion form” of the control point T refers to a motion form in which the control point T performs the custom motion.

A “free motion” of the control point T refers to any one motion of the translational motion of the control point T in the direction along each of the X axis, the Y axis, and the Z axis and the rotational motion of the control point T in the direction along each of the U axis, the V axis, and the W axis or a motion obtained by combining both of the translational motion and the rotational motion. That is, the “free motion form” of the control point T refers to a motion form in which the control point T performs the free motion.

The pulldown menu PX6 is a GUI with which the user is capable of selecting one motion form out of such predetermined one or more motion forms (in this example, the five motion forms explained above). When the pulldown menu PX6 is clicked (tapped) by the user (i.e., when selection of the pulldown menu PX6 is received), the display control section 461 reads out, from the storing section 42, motion form information, which is information stored in the storing section 42 in advance and indicates each of the one or more motion forms. The display control section 461 causes the display section 45 to display a list including the read-out one or more kind of motion form information.

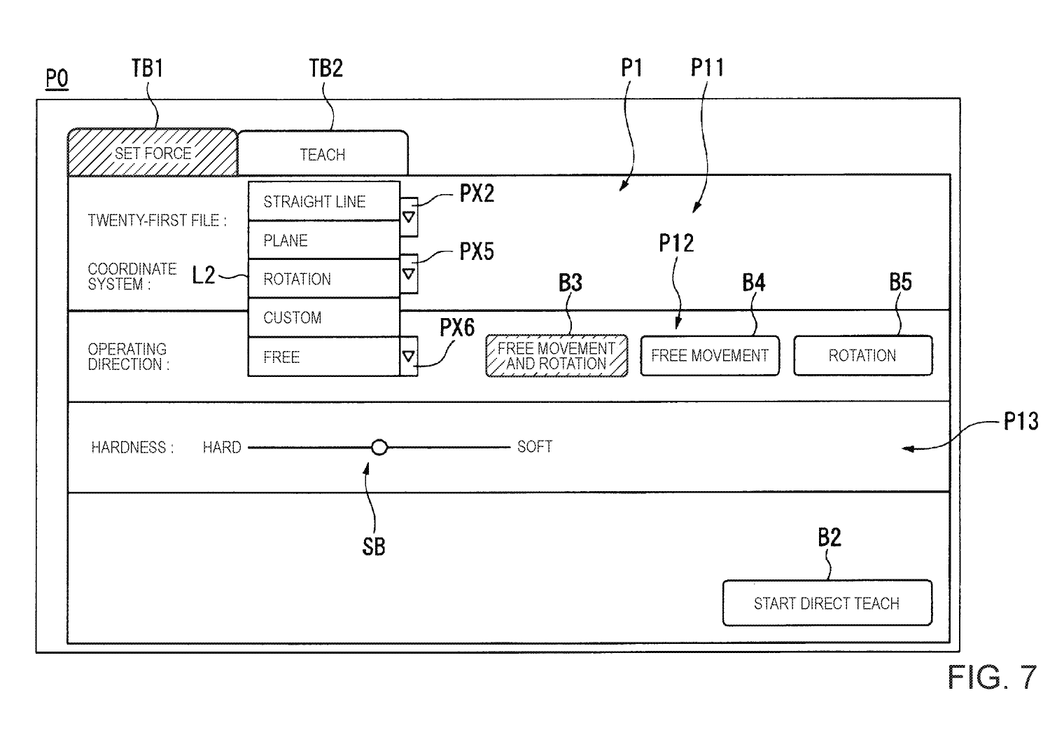

FIG. 7 is a diagram showing an example of the screen P0 displayed when the pulldown menu PX6 on the screen P0 shown in FIG. 5 is clicked (tapped) by the user. As explained above, in this case (i.e., when selection of the pulldown menu PX6 is received), the display control section 461 displays, for example, a list including one or more motion form information selectable in the second setting form. A list L2 shown in FIG. 7 is an example of the list. In the example shown in FIG. 7, in the list L2, information in which “straight line”, which is motion form information indicating the linear motion form, “plane”, which is motion form information indicating the planar motion form, “rotation”, which is motion form information indicating the rotational motion form, “custom”, which is motion form information indicating the custom motion form, and “free”, which is motion form information indicating the free motion information, respectively indicate five motion forms is displayed. Note that, in the list, other motion form information may be displayed instead of a part or all of the “straight line”, the “plane”, the “rotation”, the “custom”, and the “free” or other motion form information may be displayed in addition to the “straight line”, the “plane”, the “rotation”, the “custom”, and the “free”.

When certain motion form information is clicked (tapped) by the user in the list L2 (i.e., when selection of a motion form indicated by the motion form information is received), the display control section 461 erases the display of the list L2 from the display section 45. The display control section 461 displays the selected motion form information in the pulldown menu PX6 and displays, in the region P12, one or more GUIs for setting a second setting item corresponding to the motion form indicated by the motion form information. Each of the buttons B3 to B5 shown in FIG. 6 is an example of the one or more GUIs for setting a second setting item corresponding to the free motion form indicated by the “free”, which is the motion form information displayed in the pulldown menu PX6 shown in FIG. 6.

### A8-3-1. Setting of the Free Motion Form

When the “free” is displayed in the pulldown menu PX6 as shown in FIG. 6, the display control section 461 displays, in the region P12, each of the buttons B3 to B5, which are three GUIs for setting, for example, the second setting item corresponding to the free motion form indicated by the “free”. The second setting item corresponding to the free motion form is a setting item for allowing the control point T to perform, as the free motion, any one motion among the “translational motion” of the control point T in the direction along each of the X axis, the Y axis, and the Z axis in the reference coordinate system, the “rotational motion” of the control point T in the direction along each of the U axis, the V axis, and the W axis in the reference coordinate system, and a “composite motion” obtained by combining the translational motion and the rotational motion.

When information indicating the “translational motion” is set in the second setting item as the second setting information, the robot control device 30 executes the force control in the direct teaching as explained below. That is, when receiving an external force from the user in the direct teaching, the robot control device 30 causes the control point T to perform the translational motion as the free motion. When information indicating the “rotational motion” is set in the second setting item as the second setting information, the robot control device 30 executes the force control in the direct teaching as explained below. That is, when receiving an external force from the user in the direct teaching, the robot control device 30 causes the control point T to perform the rotational motion as the free motion. When information indicating the “composite motion” is set in the second setting item as the second setting information, the robot control device 30 executes the force control in the direct teaching as explained below. That is, when receiving an external force from the user in the direct teaching, the robot control device 30 causes the control point T to perform the composite motion as the free motion.

The button B3 is a button for setting, in the second setting item corresponding to the free motion form, as the second setting information, information indicating the “composite motion” obtained by combining the translational motion of the control point T in the direction along each of the X axis, the Y axis, and the Z axis in the reference coordinate system and the rotational motion of the control point T in the direction along each of the U axis, the V axis, and the W axis in the reference coordinate system. The button B4 is a button for setting, in the second setting item, information indicating the “translational motion” as the second setting information. The button B5 is a button for setting, in the second setting item, information indicating the “rotational motion” as the second setting information.

The first setting information corresponding to the information indicating the “composite motion” obtained by combining the translational motion of the control point T in the direction along each of the X axis, the Y axis, and the Z axis in the reference coordinate system and the rotational motion of the control point T in the direction along each of the U axis, the V axis, and the W axis in the reference coordinate system is the first setting information set in each of the six first setting items of (3) to(8) described above. A list shown below is a list of the first setting information set in the first setting items.

The first setting information set in the first setting item of (3): information indicating permission of the translational motion of the control point T in the direction along the X axis in the reference coordinate system indicated by the reference coordinate system information displayed in the pulldown menu PX5

The first setting information set in the first setting item of (4): information indicating permission of the translational motion of the control point T in the direction along the Y axis in the reference coordinate system

The first setting information set in the first setting item of (5): information indicating permission of the translational motion of the control point T in the direction along the Z axis in the reference coordinate system

The first setting information set in the first setting item of (6): information indicating permission of the rotational motion of the control point T in the direction along the U axis in the reference coordinate system

The first setting information set in the first setting item of (7): information indicating permission of the rotational motion of the control point T in the direction along the V axis in the reference coordinate system

The first setting information set in the first setting item of (8): information indicating permission of the rotational motion of the control point T in the direction along the W axis in the reference coordinate system

In the following explanation, for convenience of the explanation, setting, in the twenty-second file, the information (specifically, a numerical value “1”) indicating permission of the translational motion of the control point Tin the direction along the X axis in the reference coordinate system as the first setting information set in the first setting item of (3) is referred to as “setting (3) to permission”. Setting, in the twenty-second file, information (specifically, a numerical value “0”) indicating non-permission of the translational motion as the first setting information set in the first setting item of (3) is referred to as “setting (3) to non-permission”. The same description is applied to permission/non-permission of the translational motion of the control point T in the direction along the Y axis and permission/non-permission of the translational motion of the control point T in the direction along the Z axis.

That is, in the following explanation, setting, in the twenty-second file, the information (specifically, a numerical value “1”) indicating permission of the translational motion of the control point T in the direction along the Y axis in the reference coordinate system as the first setting information set in the first setting item of (4) is referred to as “setting (4) to permission”. Setting, in the twenty-second file, information (specifically, a numerical value “0”) indicating non-permission of the translational motion as the first setting information set in the first setting item of (4) is referred to as “setting (4) to non-permission”. In the following explanation, setting, in the twenty-second file, the information (specifically, a numerical value “1”) indicating permission of the translational motion of the control point T in the direction along the Z axis in the reference coordinate system as the first setting information set in the first setting item of (5) is referred to as “setting (5) to permission”. Setting, in the twenty-second file, information (specifically, a numerical value “0”) indicating non-permission of the translational motion as the first setting information set in the first setting item of (5) is referred to as “setting (5) to non-permission”.

In the following explanation, setting, in the twenty-second file, the information (specifically, a numerical value “1”) indicating permission of the rotational motion of the control point T in the direction along the U axis in the reference coordinate system as the first setting information set in the first setting item of (6) is referred to as “setting (6) to permission”. Setting, in the twenty-second file, information (specifically, a numerical value “0”) indicating non-permission of the rotational motion as the first setting information set in the first setting item of (6) is referred to as “setting (6) to non-permission”. The same description is applied to permission/non-permission of the rotational motion of the control point T in the direction along the V axis and permission/non-permission of the rotational motion of the control point T in the direction along the W axis.

That is, in the following explanation, setting, in the twenty-second file, the information (specifically, a numerical value “1”) indicating permission of the rotational motion of the control point T in the direction along the V axis in the reference coordinate system as the first setting information set in the first setting item of (7) is referred to as “setting (7) to permission”. Setting, in the twenty-second file, information (specifically, a numerical value “0”) indicating non-permission of the rotational motion as the first setting information set in the first setting item of (7) is referred to as “setting (7) to non-permission”. In the following explanation, setting, in the twenty-second file, the information (specifically, a numerical value indicating permission of the rotational motion of the control point T in the direction along the W axis in the reference coordinate system as the first setting information set in the first setting item of (8) is referred to as “setting (8) to permission”. Setting, in the twenty-second file, information (specifically, a numerical value “0”) indicating non-permission of the rotational motion as the first setting information set in the first setting item of (8) is referred to as “setting (8) to non-permission”.

When the button B3 is clicked (tapped) by the user in FIG. 6 (i.e., when the selection of the button B3 is received), the display control section 461 displays, on the display section 45, information indicating that the button B3 is clicked. The setting control section 463 sets each of (3) to (8) to permission. This is explained more specifically below.

Table 1 is a table showing setting values of the second setting item input to the teaching device 40 according to operation of the buttons by the user on the screen P0 and setting values of the six first setting items associated with the setting values of the second setting item. In upper parts of columns in Table 1, the setting values of the second setting item (e.g., a combination of “free” in the top part and “movement and rotation” under the top part, a combination of “free” in the top part and “movement” under the top part, and the like) are shown. At the left ends of rows in Table 1, the first setting items (e.g., “Fx_Enabled” and “Fy_Enabled”) are shown. In fields in Table 1, “1” indicates permission and “0” indicates non-permission.

Note that data storing the information of Table 1 is stored in a storing section included in the robot control device 30 (see FIG. 3). The storing section of the robot control device 30, in which the information of Table 1 is stored, is a nonvolatile memory. The data storing the information of Table 1 is readout from the storing section of the robot control device 30 by the control device 46 and stored in the storing section 42 (see FIG. 2) of the teaching device 40. The storing section 42 of the teaching device 40, in which the information of Table 1 is stored, is a volatile memory. The control device 46 performs setting of the motion forms referring to the data storing the information of Table 1 in the storing section 42.

TABLE 1

| | Free | | | | | | | | | | | |
|---|---|---|---|---|---|---|---|---|---|---|---|---|
| | Movement | | | Straight | | | | | | | | |
| | and | | | line | | | Plane | | | Rotation | | |
| | rotation | Movement | Rotation | X | Y | Z | XY | YZ | XZ | RX | RY | RZ |
| Fx_Enabled | 1 | 1 | 0 | 1 | 0 | 0 | 1 | 0 | 1 | 0 | 0 | 0 |
| Fy_Enabled | 1 | 1 | 0 | 0 | 1 | 0 | 1 | 1 | 0 | 0 | 0 | 0 |
| Fz_Enabled | 1 | 1 | 0 | 0 | 0 | 1 | 0 | 1 | 1 | 0 | 0 | 0 |
| Tx_Enabled | 1 | 0 | 1 | 0 | 0 | 0 | 0 | 0 | 0 | 1 | 0 | 0 |
| Ty_Enabled | 1 | 0 | 1 | 0 | 0 | 0 | 0 | 0 | 0 | 0 | 1 | 0 |
| Tz_Enabled | 1 | 0 | 1 | 0 | 0 | 0 | 0 | 0 | 0 | 0 | 0 | 1 |

For example, in Table 1, “Fx_Enabled” indicates setting of (3) described above, that is, propriety of translation of the control point T in the direction along the X axis in the reference coordinate system. “Fy_Enabled” indicates setting of (4) described above, that is, propriety of translation of the control point T in the direction along the Y axis in the reference coordinate system. “Fz_Enabled” indicates setting of (5) described above, that is, propriety of translation of the control point T in the direction along the Z axis in the reference coordinate system.

In Table 1, “Tx_Enabled” indicates setting of (6) described above, that is, propriety of rotation of the control point T in the direction along the U axis in the reference coordinate system. “Ty_Enabled” indicates setting of (7) described above, that is, propriety of rotation of the control point T in the direction along the V axis in the reference coordinate system. “Tz_Enabled” indicates setting of (8) described above, that is, propriety of rotation of the control point T in the direction along the W axis in the reference coordinate system.

When the user operates the buttons on the screen P0 shown in FIG. 6 and a setting value of the second setting item is input, the setting control section 463 (see FIG. 3) of the control device 46 refers to data equivalent to Table 1 in the storing section 42. For example, as shown in FIG. 6, the “free” is selected in the pulldown menu PX6 and the button B3 meaning selection of the “movement and rotation” is turned on, whereby the input of the setting value of the second setting item is performed. Then, the setting control section 463 refers to the columns of the “free” and the “movement and rotation” in Table 1 and acquires a value (specifically, 1 or 0) of the first setting items such as “Fx_Enabled” and “Fy_Enabled”. In this case, setting values of all of the first setting items “Fx_Enabled” to “Tz_Enabled” are “1” (permission)”. The setting control section 463 sets the values of the first setting items “Fx_Enabled” to “Tz_Enabled” associated with the “free” and the “movement and rotation” serving as the setting values of the second setting item to the acquired values. “The setting control section 463 sets each of (3) to (8) to permission” specifically means that the setting control section 463 executes processing explained below.

On the other hand, the first setting information corresponding to the information indicating the translational motion of the control point T in the direction along each of the X axis, the Y axis, and the Z axis in the reference coordinate system is information for setting each of (3) to (5) to permission and setting each of (6) to (8) to non-permission.

That is, when the button B4 is clicked (tapped) by the user (i.e., when selection of the button B4 is received) in FIG. 6, the display control section 461 displays, on the display section (a display) 45, information indicating that the button B4 is clicked. The setting control section 463 sets each of (3) to (5) to permission and sets each of (6) to (8) to non-permission. This setting corresponds to the setting values of the first setting items “Fx_Enabled” to “Tz_Enabled” at the time when the second setting information indicates the “free” and the “movement” in Table 1.

The first setting information corresponding to the information indicating the rotational motion of the control point T in the direction along each of the U axis, the V axis, and the W axis in the reference coordinate system is information for setting each of (3) to (5) to non-permission and setting each of (6) to (8) to permission.

That is, when the button B5 is clicked (tapped) by the user in FIG. 6 (i.e., when selection of the button B5 is received), the display control section 461 displays, on the display section 45, information indicating that the button B5 is clicked. The setting control section 463 sets each of (3) to (5) to non-permission and sets each of (6) to (8) to permission. This setting corresponds to the respective setting values of the first setting items “Fx_Enabled” to “Tz_Enabled” at the time when the second setting information indicates the “free” and the “rotation” in Table 1.

### A8-3-2. Setting of the Linear Motion Form

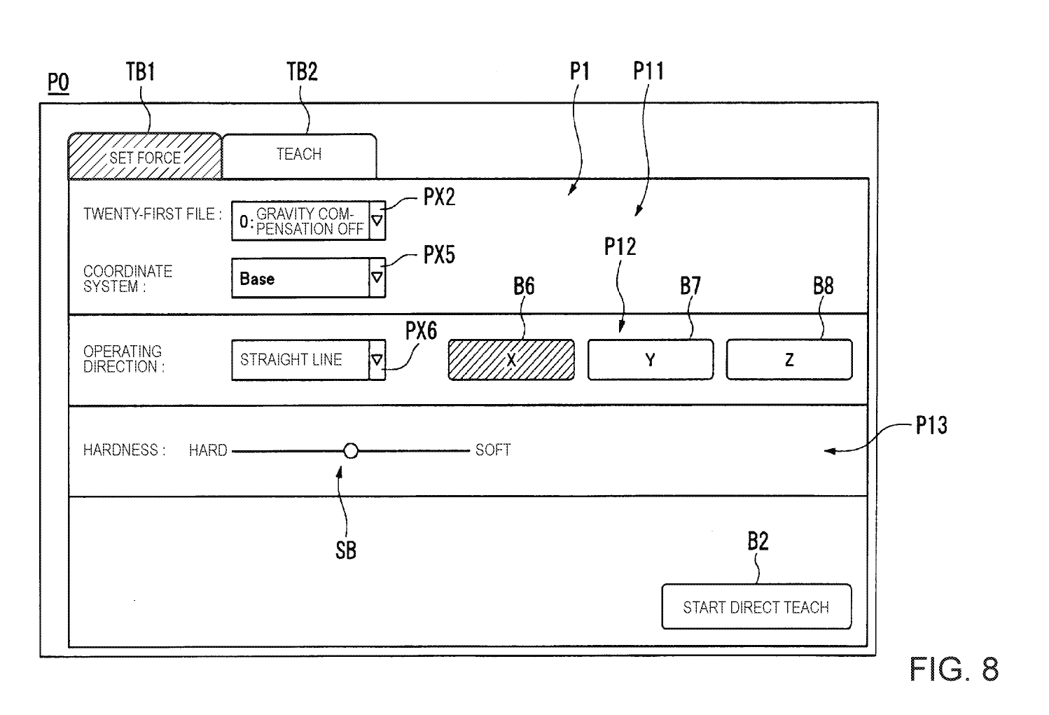

FIG. 8 is a diagram showing an example of the screen P0 at the time when the linear motion form information is clicked by the user in the list L2 shown in FIG. 7. When the linear motion form information is clicked (tapped) by the user in the list L2 shown in FIG. 7 (i.e., when selection of the linear motion form indicated by the linear motion form information is received), the display control section 461 erases the display of the list L2 from the display section 45. The display control section 461 displays the “straight line”, which is the linear motion form information, in the pulldown menu PX6 and displays, in the region P12, one or more GUIs for setting a second setting item corresponding to the linear motion form indicated by the linear motion form information. Each of buttons B6 to B8 shown in FIG. 8 is an example of the one or more GUIs for setting the second setting item corresponding to the linear motion form indicated by the “straight line”.

When the “straight line” is displayed in the pulldown menu PX6 as shown in FIG. 8, for example, the display control section 461 displays, in the region P12, each of the buttons B6 to B8, which are three GUIs for setting the second setting item corresponding to the linear motion form indicated by the “straight line”. The second setting item corresponding to the linear motion form is a setting item for allowing the control point T to perform, as the linear motion, the translational motion of the control point T in the direction along any one axis among the X axis, the Y axis, and the Z axis in the reference coordinate system.

When information indicating the translational motion of the control point T in the direction along the X axis is set in the second setting item as the second setting information, the robot control device 30 executes the force control in the direct teaching as explained below. That is, when receiving an external force from the user in the direct teaching, the robot control device 30 causes the control point T to perform the translational motion in the direction along the X axis as the linear motion. In other words, in the direct teaching, the direction along the X axis is set as a direction in which the robot 20 is movable.

When information indicating the translational motion of the control point T in the direction along the Y axis is set in the second setting item as the second setting information, the robot control device 30 executes the force control in the direct teaching as explained below. That is, when receiving an external force from the user in the direct teaching, the robot control device 30 causes the control point T to perform the translational motion in the direction along the Y axis as the linear motion. In other words, in the direct teaching, the direction along the Y axis is set as a direction in which the robot 20 is movable.

When information indicating the translational motion of the control point T in the direction along the Z axis is set in the second setting item as the second setting information, the robot control device 30 executes the force control in the direct teaching as explained below. That is, when receiving an external force from the user in the direct teaching, the robot control device 30 causes the control point T to perform the translational motion in the direction along the Z axis as the linear motion. In other words, in the direct teaching, the direction along the Z axis is set as a direction in which the robot 20 is movable.

The button B6 is a button for setting, in the second setting item corresponding to the linear motion form, as the second setting information, information indicating the translational motion of the control point T in the direction along the X axis in the reference coordinate system. The button B7 is a button for setting, in the second setting item, as the second setting information, information indicating the translational motion of the control point T in the direction along the Y axis in the reference coordinate system. The button B8 is a button for setting, in the second setting item, as the second setting information, information indicating the translational motion of the control point T in the direction along the Z axis in the reference coordinate system.

The first setting information corresponding to the information indicating the translational motion of the control point T in the direction along the X axis in the reference coordinate system is information for setting (3) to permission and setting each of (4) to (8) to non-permission.

That is, when the button B6 is clicked (tapped) by the user (i.e., when selection of the button B6 is received), the display control section 461 displays, on the display section 45, information indicating that the button B6 is clicked. The setting control section 463 sets (3) to permission and sets each of (4) to (8) to non-permission. This setting corresponds to the setting values of the first setting items “Fx_Enabled” to “Tz_Enabled” at the time when the second setting information indicates the “straight line” and “X” in Table 1.

The first setting information corresponding to the information indicating the translational motion of the control point T in the direction along the Y axis in the reference coordinate system is information for setting (4) to permission and setting each of (3) and (5) to (8) to non-permission.

That is, when the button B7 is clicked (tapped) by the user (i.e., when selection of the button B7 is received), the display control section 461 displays, on the display section 45, information indicating that the button B7 is clicked. The setting control section 463 sets (4) to permission and sets each of (3) and (5) to (8) to non-permission. This setting corresponds to the setting values of the first setting items “Fx_Enabled” to “Fz_Enabled” at the time when the second setting information indicates the “straight line” and “Y” in Table 1.

The first setting information corresponding to the information indicating the translational motion of the control point T in the direction along the Z axis in the reference coordinate system is information for setting (5) to permission and setting each of (3) and (4) and (6) to (8) to non-permission.

That is, when the button B8 is clicked (tapped) by the user (i.e., when selection of the button B8 is received), the display control section 461 displays, on the display section 45, information indicating that the button B8 is clicked. The setting control section 463 sets (5) to permission and sets each of (3) and (4) and (6) to (8) to non-permission. This setting corresponds to the setting values of the first setting items “Fx_Enabled” to “Tz_Enabled” at the time when the second setting information indicates the “straight line” and “Z” in Table 1.

By performing the processing explained above, a user nonproficient in the setting of the first setting items can easily perform, using the screen P0 of the second setting form displayed on the display section 45, setting of setting values of the first setting items for setting one direction among directions of axes in a three-dimensional orthogonal coordinate system as a movable direction.

### A8-3-3. Setting of the Planar Motion Form

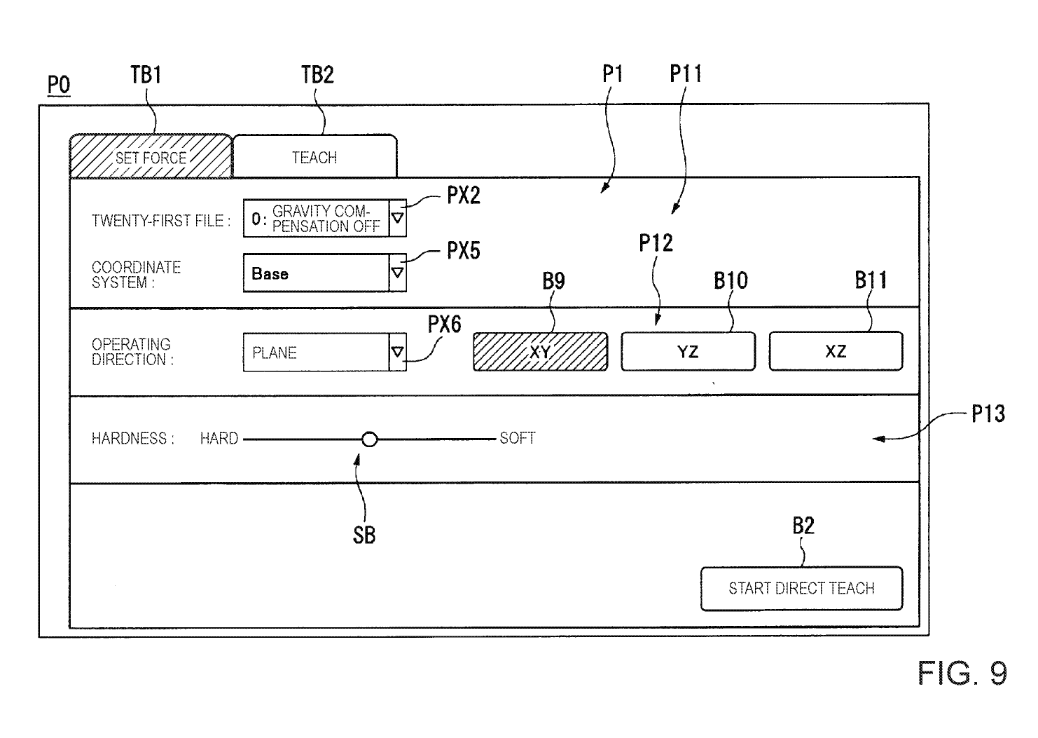

FIG. 9 is a diagram showing an example of the screen P0 at the time when the planar motion form information is clicked by the user in the list L2 shown in FIG. 7. When the planar motion form information is clicked (tapped) by the user in the list L2 shown in FIG. 7 (i.e., when selection of the planar motion form indicated by the planar motion form information is received), the display control section 461 erases the display of the list L2 from the display section 45. The display control section 461 displays the “plane”, which is the planar motion form information, in the pulldown menu PX6 and displays, in the region P12, one or more GUIs for setting a second setting item corresponding to the planar motion form indicated by the planar motion form information. Each of buttons B9 to B11 shown in FIG. 9 is an example of the one or more GUIs for setting the second setting item corresponding to the planar motion form indicated by the “plane”.

When the “plane” is displayed in the pulldown menu PX6 as shown in FIG. 9, for example, the display control section 461 displays, in the region P12, each of the buttons B9 to B11, which are three GUIs for setting the second setting item corresponding to the planar motion form indicated by the “plane”. The second setting item corresponding to the planar motion form is a setting item for allowing the control point T to perform, as the planar motion, the translational motion of the control point T in the direction along the plane defined by any two axes among the X axis, the Y axis, and the Z axis in the reference coordinate system.

When information indicating a translational motion of the control point T in a direction along a plane defined by the X axis and the Y axis is set in the second setting item as the second setting information, the robot control device executes the force control in the direct teaching as explained below. That is, when receiving an external force from the user in the direct teaching, the robot control device 30 causes the control point T to perform, as the planar motion, the translational motion in the direction along the plane defined by the X axis and the Y axis. In other words, in the direct teaching, the directions of the X axis and the Y axis are set as directions of two axes that the moving direction of the robot 20 can include as direction components.

When information indicating a translational motion of the control point T in a direction along a plane defined by the Y axis and the Z axis is set in the second setting item as the second setting information, the robot control device 30 executes the force control in the direct teaching as explained below. That is, when receiving an external force from the user in the direct teaching, the robot control device 30 causes the control point T to perform, as the planar motion, the translational motion in the direction along the plane defined by the Y axis and the Z axis. In other words, in the direct teaching, the directions of the Y axis and the Z axis are set as directions of two axes that the moving direction of the robot 20 can include as direction components.

When information indicating a translational motion of the control point T in a direction along a plane defined by the Z axis and the X axis is set in the second setting item as the second setting information, the robot control device 30 executes the force control in the direct teaching as explained below. That is, when receiving an external force from the user in the direct teaching, the robot control device 30 causes the control point T to perform, as the planar motion, the translational motion in the direction along the plane defined by the Z axis and the X axis. In other words, in the direct teaching, the directions of the Z axis and the X axis are set as directions of two axes that the moving direction of the robot 20 can include as direction components.

The button B9 is a button for setting, in the second setting item corresponding to the planar motion form, as the second setting information, information indicating the translational motion of the control point T in the direction along the plane defined by the X axis and the Y axis in the reference coordinate system. The button B10 is a button for setting, in the second setting item corresponding to the planar motion form, as the second setting information, information indicating the translational motion of the control point T in the direction along the plane defined by the Y axis and the Z axis in the reference coordinate system. The button B11 is a button for setting, in the second setting item corresponding to the planar motion form, as the second setting information, information indicating the translational motion of the control point T in the direction along the plane defined by the Z axis and the X axis.

The first setting information corresponding to the information indicating the translational motion of the control point T in the direction along the plane defined by the X axis and the Y axis in the reference coordinate system is information for setting each of (3) and (4) to permission and setting each of (5) to (8) to non-permission.

That is, when the button B9 is clicked (tapped) by the user (i.e., when selection of the button B9 is received), the display control section 461 displays, on the display section 45, information indicating that the button B9 is clicked. The setting control section 463 sets each of (3) and (4) to permission and sets each of (5) to (8) to non-permission. This setting corresponds to the setting values of the first setting items “Fx_Enabled” to “Tz_enabled” at the time when the second setting information indicates the “plane” and “XY” in Table 1.

The first setting information corresponding to the information indicating the translational motion of the control point T in the direction along the plane defined by the Y axis and the Z axis in the reference coordinate system is information for setting each of (4) and (5) to permission and setting each of (3) and (6) to (8) to non-permission.

That is, when the button B10 is clicked (tapped) by the user (i.e., when selection of the button B10 is received), the display control section 461 displays, on the display section 45, information indicating that the button B10 is clicked. The setting control section 463 sets each of (4) and (5) to permission and sets each of (3) and (6) to (8) to non-permission. This setting corresponds to the setting values of the first setting items “Fx_Enabled” to “Tz_Enabled” at the time when the second setting information indicates the “plane” and “YZ” in Table 1.

The first setting information corresponding to the information indicating the translational motion of the control point T in the direction along the plane defined by the Z axis and the X axis in the reference coordinate system is information for setting each of (3) to (5) to permission and setting each of (4) and (6) to (8) to non-permission.

That is, when the button B11 is clicked (tapped) by the user (i.e., when selection of the button B11 is received), the display control section 461 displays, on the display section 45, information indicating that the button B11 is clicked. The setting control section 463 sets each of (3) and (5) to permission and sets each of (4) and (6) to (8) to non-permission. This setting corresponds to the setting values of the first setting items “Fx_Enabled” to “Tz_Enabled” at the time when the second setting information indicates the “plane” and “XZ” in Table 1.

By performing the processing explained above, a user nonproficient in the setting of the first setting items can easily perform, using the screen P0 of the second setting form displayed on the display section 45, setting of setting values of two first setting items for enabling the robot to move in a direction including, as direction components, two directions among directions of axes in a three-dimensional coordinate system.

### A8-3-4. Setting of the Rotational Motion Form

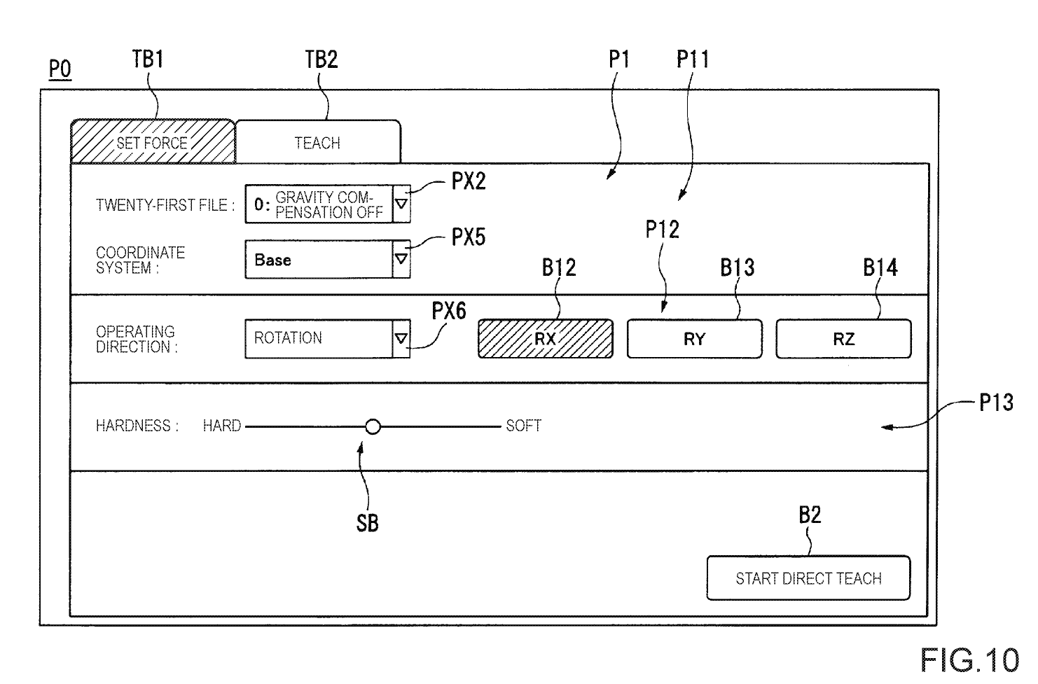

FIG. 10 is a diagram showing an example of the screen P0 displayed when the rotational motion form information is clicked by the user in the list L2 shown in FIG. 7. When the rotational motion form information is clicked (tapped) by the user in the list L2 shown in FIG. 7 (i.e., when selection of the rotational motion form indicated by the rotational motion form information is received), the display control section 461 erases the display of the list L2 from the display section 45. The display control section 461 displays the “rotation”, which is the rotational motion form information, in the pulldown menu PX6 and displays, in the region P12, one or more GUIs for setting a second setting item corresponding to the rotational motion form indicated by the rotational motion form information. Each of buttons B12 to B14 shown in FIG. 10 is an example of one or more GUIs for setting the second setting item corresponding to the rotational motion form indicated by the “rotation”.

When the “rotation” is displayed in the pulldown menu PX6 as shown in FIG. 10, the display control section 461 displays, in the region P12, each of the buttons B12 to B14, which are three GUIs for setting the second setting item corresponding to the rotational motion form indicated by the “rotation”. The second setting item corresponding to the rotational motion form is a setting item for allowing the control point T to perform a rotational motion of the control point T in a direction along any one axis among the U axis, the V axis, and the W axis in the reference coordinate system.

When information indicating the rotational motion of the control point T in the direction along the U axis is set in the second setting item as the second setting information, the robot control device 30 executes the force control in the direct teaching as explained below. That is, when receiving an external force from the user in the direct teaching, the robot control device 30 allows the control point T to perform the rotational motion in the direction along the U axis. When information indicating the rotational motion of the control point T in the direction along the V axis is set in the second setting item as the second setting information, the robot control device 30 executes the force control in the direct teaching as explained below. That is, when receiving an external force from the user in the direct teaching, the robot control device 30 allows the control point T to perform the rotational motion in the direction along the V axis. When information indicating the rotational motion of the control point T in the direction along the W axis is set in the second setting item as the second setting information, the robot control device 30 executes the force control in the direct teaching as explained below. That is, when receiving an external force from the user in the direct teaching, the robot control device 30 allows the control point T to perform the rotational motion in the direction along the W axis.

The button B12 is a button for setting, in the second setting item corresponding to the rotational motion form, as the second setting information, information indicating the rotational motion of the control point T in the direction along the U axis in the reference coordinate system. The button B13 is a button for setting, in the second setting item corresponding to the rotational motion form, as the second setting information, the information indicating the rotational motion of the control point T in the direction along the V axis in the reference coordinate system. The button B14 is a button for setting, in the second setting item corresponding to the rotational motion form, as the second setting information, information indicating the rotational motion of the control point T in the direction along the W axis in the reference coordinate system.

The first setting information corresponding to the information indicating the rotational motion of the control point T in the direction along the U axis in the reference coordinate system is information for setting (6) to permission and setting each of (3) to (5) and (7) and (8) to non-permission.

That is, when the button B12 is clicked (tapped) by the user (i.e., when selection of the button B12 is received), the display control section 461 displays, on the display section 45, information indicating that the button B12 is clicked. The setting control section 463 sets (6) to permission and sets each of (3) to (5) and (7) and (8) to non-permission. This setting corresponds to the setting values of the first setting items “Fx_Enabled” to “Tz_Enabled” at the time when the second setting information indicates the “rotation” and “RX” in Table 1.

The first setting information corresponding to the information indicating the rotational motion of the control point T in the direction along the V axis in the reference coordinate system is information for setting (7) to permission and setting each of (3) to (6) and (8) to non-permission.

That is, when the button B13 is clicked (tapped) by the user (i.e., when selection of the button B13 is received), the display control section 461 displays, on the display section 45, information indicating that the button B13 is clicked. The setting control section 463 sets (7) to permission and sets each of (3) to (6) and (8) to non-permission. This setting corresponds to the setting values of the first setting items “Fx_Enabled” to “Tz_Enabled” at the time when the second setting information indicates the “rotation” and “RY” in Table 1.

The first setting information corresponding to the information indicating the rotational motion of the control point T in the direction along the W axis in the reference coordinate system is information for setting (8) to permission and setting each of (3) to (7) to non-permission.

That is, when the button B14 is clicked (tapped) by the user (i.e., when selection of the button B14 is received), the display control section 461 displays, on the display section 45, information indicating that the button B14 is clicked. The setting control section 463 sets (8) to permission and sets each of (3) to (7) to non-permission. This setting corresponds to the setting values of the first setting items “Fx_Enabled” to “Tz_Enabled” at the time when the second setting information indicates the “rotation” and “RZ” in Table 1.

A8-3-5. Setting of the Custom Motion Form

When the customer motion form information is clicked (tapped) by the user in the list L2 shown in FIG. 7 (i.e., when selection of the custom motion form indicated by the custom motion form information is received), the display control section 461 erases the display of the list L2 from the display section 45. The display control section 461 displays the “custom”, which is the custom motion form information, in the pulldown menu PX6 and displays, in the region P12, one or more GUIs for setting a second setting item corresponding to the custom motion form indicated by the custom motion form information.

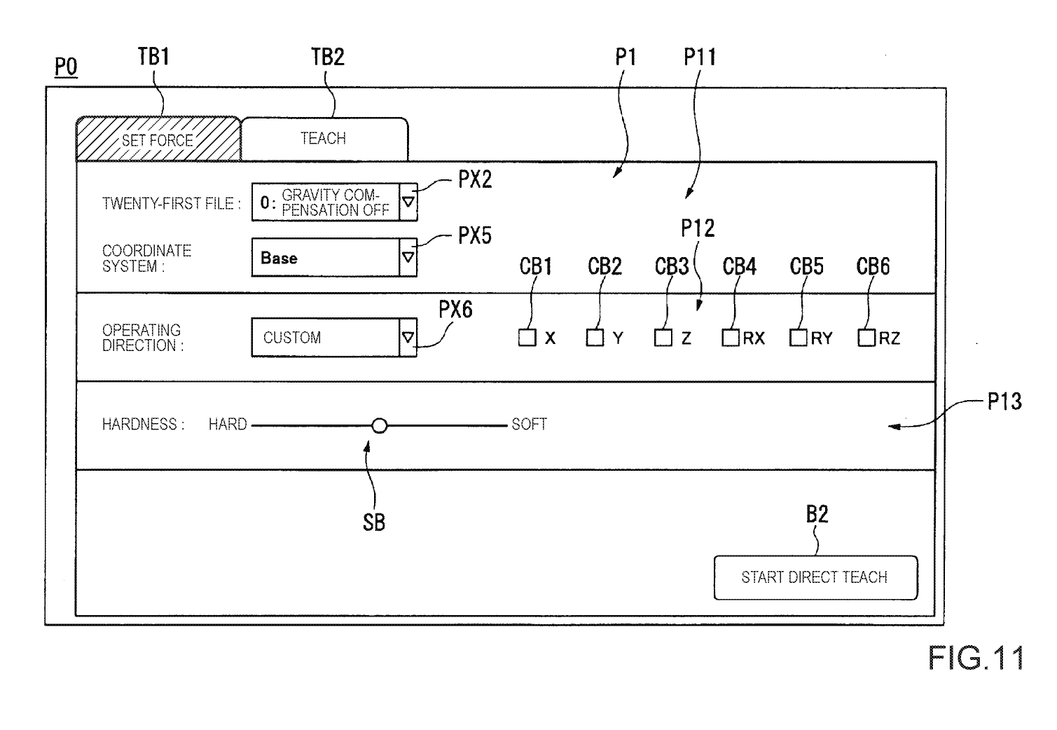

FIG. 11 is a diagram showing an example of the screen P0 at the time when the custom motion form information is clicked by the user in the list L2 shown in FIG. 7. Each of checkboxes CB1 to CB6 shown in FIG. 11 is an example of one or more GUIs for setting the second setting item corresponding to the custom motion form indicated by the “custom”.

When the “custom” is displayed in the pulldown menu PX6 as shown in FIG. 11, for example, the display control section 461 displays, in the region P12, each of the checkboxes CB1 to CB6, which are six checkboxes for setting the second setting item corresponding to the custom motion form indicated by the “custom”.

The checkbox CB1 is a GUI with which the user is capable of selecting the X axis in the reference coordinate system. When the checkbox CB1 is clicked (tapped) by the user (i.e., when selection of the checkbox CB1 is received) in a state in which information indicating that the checkbox CB1 is clicked is not displayed in the checkbox CB1, the display control section 461 displays, in the checkbox CB1, the information indicating that the checkbox CB1 is clicked. On the other hand, when the checkbox CB1 is clicked (tapped) by the user (i.e., when selection of the checkbox CB1 is received) in a state in which the information indicating that the checkbox CB1 is clicked is displayed in the checkbox CB1, the display control section 461 deletes, from the checkbox CB1, the information indicating that the checkbox CB1 is clicked.

The checkbox CB2 is a GUI with which the user is capable of selecting the Y axis in the reference coordinate system. When the checkbox CB2 is clicked (tapped) by the user (i.e., when selection of the checkbox CB2 is received) in a state in which information indicating that the checkbox CB2 is clicked is not displayed in the checkbox CB2, the display control section 461 displays, in the checkbox CB2, the information indicating that the checkbox CB2 is clicked. On the other hand, when the checkbox CB2 is clicked (tapped) by the user (i.e., when selection of the checkbox CB2 is received) in a state in which the information indicating that the checkbox CB2 is clicked is displayed in the checkbox CB2, the display control section 461 deletes, from the checkbox CB2, the information indicating that the checkbox CB2 is clicked.

The checkbox CB3 is a GUI with which the user is capable of selecting the Z axis in the reference coordinate system. When the checkbox CB3 is clicked (tapped) by the user (i.e., when selection of the checkbox CB3 is received) in a state in which information indicating that the checkbox CB3 is clicked is not displayed in the checkbox CB3, the display control section 461 displays, in the checkbox CB3, the information indicating that the checkbox CB3 is clicked. On the other hand, when the checkbox CB3 is clicked (tapped) by the user (i.e., when selection of the checkbox CB3 is received) in a state in which the information indicating that the checkbox CB3 is clicked is displayed in the checkbox CB3, the display control section 461 deletes, from the checkbox CB3, the information indicating that the checkbox CB3 is clicked.

The checkbox CB4 is a GUI with which the user is capable of selecting the U axis in the reference coordinate system. When the checkbox CB4 is clicked (tapped) by the user (i.e., when selection of the checkbox CB4 is received) in a state in which information indicating that the checkbox CB4 is clicked is not displayed in the checkbox CB4, the display control section 461 displays, in the checkbox CB4, the information indicating that the checkbox CB4 is clicked. On the other hand, when the checkbox CB4 is clicked (tapped) by the user (i.e., when selection of the checkbox CB4 is received) in a state in which the information indicating that the checkbox CB4 is clicked is displayed in the checkbox CB4, the display control section 461 deletes, from the checkbox CB4, the information indicating that the checkbox CB4 is clicked.

The checkbox CB5 is a GUI with which the user is capable of selecting the V axis in the reference coordinate system. When the checkbox CB5 is clicked (tapped) by the user (i.e., when selection of the checkbox CB5 is received) in a state in which information indicating that the checkbox CB5 is clicked is not displayed in the checkbox CB5, the display control section 461 displays, in the checkbox CB5, the information indicating that the checkbox CB5 is clicked. On the other hand, when the checkbox CB5 is clicked (tapped) by the user (i.e., when selection of the checkbox CB5 is received) in a state in which the information indicating that the checkbox CB5 is clicked is displayed in the checkbox CB5, the display control section 461 deletes, from the checkbox CB5, the information indicating that the checkbox CB5 is clicked.

The checkbox CB6 is a GUI with which the user is capable of selecting the W axis in the reference coordinate system. When the checkbox CB6 is clicked (tapped) by the user (i.e., when selection of the checkbox CB6 is received) in a state in which information indicating that the checkbox CB6 is clicked is not displayed in the checkbox CB6, the display control section 461 displays, in the checkbox CB6, the information indicating that the checkbox CB6 is clicked. On the other hand, when the checkbox CB6 is clicked (tapped) by the user (i.e., when selection of the checkbox CB6 is received) in a state in which the information indicating that the checkbox CB6 is clicked is displayed in the checkbox CB6, the display control section 461 deletes, from the checkbox CB6, the information indicating that the checkbox CB6 is clicked.

The second setting item corresponding to the custom motion form is a setting item for allowing the control point T to perform a motion (a motion including at least one of the translational motion and the rotational motion) of the control point T in directions along respective one or more axes selected by the user with the checkboxes CB1 to CB6 among the X axis, the Y axis, the Z axis, the U axis, the V axis, and the W axis in the reference coordinate system. That is, by selecting one or more axes among the X axis, the Y axis, the Z axis, the U axis, the V axis, and the W axis with the checkboxes CB1 to CB6, the user can set, in the “custom” serving as the second setting item, the second setting information indicating the motion (including at least one of the translational motion and the rotational motion) of the control point Tin the directions along the respective selected one or more axes. When the user sets the second setting information in the second setting item, the robot control device 30 executes the force control in the direct teaching as explained below. That is, when receiving an external force from the user in the direct teaching, the robot control device 30 allows the control point T to perform motions in the directions along the respective selected one or more axes.

First setting information corresponding to the second setting information indicating the motion (the motion including at least one of the translational motion and the rotational motion) of the control point T in the directions along the respective one or more axes selected out of the X axis, the Y axis, the Z axis, the U axis, the V axis, and the W axis in the reference coordinate system by the checkboxes CB1 to CB6 is information for setting at least (3) to permission when the X axis is selected by the checkbox CB1. The first setting information is information for setting at least (4) to permission when the Y axis is selected by the checkbox CB2. The first setting information is information for setting at least (5) to permission when the Z axis is selected by the checkbox CB3. The first setting information is information for setting at least (6) to permission when the U axis is selected by the checkbox CB4. The first setting information is information for setting at least (7) to permission when the V axis is selected by the checkbox CB5. The first setting information is information for setting at least (8) to permission when the W axis is selected by the checkbox CB6.

That is, when the X axis is selected out of the X axis, the Y axis, the Z axis, the U axis, the V axis, and the W axis in the reference coordinate system by the checkbox CB1, the setting control section 463 sets (3) described above to permission. When the Y axis is selected out of the X axis, the Y axis, the Z axis, the U axis, the V axis, and the W axis by the checkbox CB2, the setting control section 463 sets (4) described above to permission. When the Z axis is selected out of the X axis, the Y axis, the Z axis, the U axis, the V axis, and the W axis by the checkbox CB3, the setting control section 463 sets (5) described above to permission. When the U axis is selected out of the X axis, the Y axis, the Z axis, the U axis, the V axis, and the W axis by the checkbox CB4, the setting control section 463 sets (6) described above to permission. When the V axis is selected out of the X axis, the Y axis, the Z axis, the U axis, the V axis, and the W axis by the checkbox CB5, the setting control section 463 sets (7) described above to permission. When the W axis is selected out of the X axis, the Y axis, the Z axis, the U axis, the V axis, and the W axis by the checkbox CB6, the setting control section 463 sets (8) described above to permission.

### A8-4. Selection of Hardness of a Movement of the Control Point T

Referring back to FIG. 6, the region P13 includes a slide bar SB. Note that the region P13 may include another GUI instead of the slide bar SB or may include another GUI in addition to the slide bar SB.

The slide bar SB is a GUI for setting a second setting item for setting hardness of a movement of the control point T by the force control in the direct teaching. Specifically, in the region P13, by moving a position of the slide bar SB, the user can set, in the second setting item, as the second setting information, information indicating the hardness of the movement of the control point T by the force control in the direct teaching and indicating hardness corresponding to the position. The hardness of the movement of the control point T is an indicator indicating difficulty (or easiness) of movement of the control point T. First setting information corresponding to information indicating hardness corresponding to each of one or more positions to which the slide bar SB can be moved is the first setting information set in the respective eighteen first setting items of (9) to (26) described above. In this embodiment, the slide bar SB can take three positions, that is, “hard” at the left end, “soft” at the right end, and the center.

In the following explanation, for convenience of the explanation, the first setting information set in the first setting item of (9) is referred to as “value of (9)”. The first setting information set in the first setting item of (10) is referred to as “value of (10)”. The first setting information set in the first setting item of (11) is referred to as “value of (11)”. The first setting information set in the first setting item of (12) is referred to as “value of (12)”. The first setting information set in the first setting item of (13) is referred to as “value of (13)”. The first setting information set in the first setting item of (14) is referred to as “value of (14)”. The first setting information set in the first setting item of (15) is referred to as “value of (15)”. The first setting information set in the first setting item of (16) is referred to as “value of (16)”. The first setting information set in the first setting item of (17) is referred to as “value of (17)”. The first setting information set in the first setting item of (18) is referred to as “value of (18)”. The first setting information set in the first setting item of (19) is referred to as “value of (19)”. The first setting information set in the first setting item of (20) is referred to as “value of (20)”. The first setting information set in the first setting item of (21) is referred to as “value of (21)”. The first setting information set in the first setting item of (22) is referred to as “value of (22)”. The first setting information set in the first setting item of (23) is referred to as “value of (23)”. The first setting information set in the first setting item of (24) is referred to as “value of (24)”. The first setting information set in the first setting item of (25) is referred to as “value of (25)”. The first setting information set in the first setting item of (26) is referred to as “value of (26)”.

By moving the position of the slide bar SB, the user can set, in a second setting item corresponding to the slide bar SB, information indicating hardness corresponding to the moved position of the slide bar SB. The setting control section 463 stores, in the twenty-second file, first setting information corresponding to the information set by the user using the slide bar SB. Consequently, the setting control section 463 sets the first setting items of (9) to (26). The respective values of respective (9) to (26) are determined in advance according to the position of the slide bar SB. In the example shown in FIG. 6, the hardness of the control point T is higher as the position of the slide bar SB is closer to the word “hard” shown in FIG. 6. On the other hand, the hardness of the control point T is lower as the position of the slide bar SB is closer to the word “soft” shown in FIG. 6.

Table 2 is a table showing a relation between setting values of the second setting item input to the teaching device 40 by operation of the slide bar SB by the user on the screen P0 and setting values of the eighteen first setting items. In upper parts of columns in Table 2, the setting values of the second setting item (i.e., “hard”, “normal”, and “soft”) are shown. At the left end of rows in Table 2, the first setting items (e.g., “Fx_Mass”, “Fx_Damper”, and “Fx_Spring”) are shown. In fields in Table 2, signs “aₓₘₕ”, “aₓₘₘ”, and “aₓₘₛ” represent specific numerical values.

Data storing the information of Table 2 is stored in the storing section included in the robot control device 30 (see FIG. 3). The storing section of the robot control device 30, in which the information of Table 2 is stored, is a nonvolatile memory. The data storing the information of Table 2 is read out from the storing section of the robot control device 30 by the control device 46 and stored in the storing section 42 (see FIG. 2) of the teaching device 40. The storing section 42 of the teaching device 40, in which the information of Table 2 is stored, is a volatile memory. The control device 46 performs setting of the hardness of the motion of the control point T referring to the data storing the information of Table 2 in the storing section 42.

TABLE 2

| | Hard | Normal | Soft |
|---|---|---|---|
| Fx_Mass | aₓₘₕ | aₓₘₘ | aₓₘₛ |
| Fx_Damper | a_{xdh} | a_{xdm} | a_{xds} |
| Fx_Spring | aₓₛₕ | aₓₛₘ | aₓₛₛ |
| Fy_Mass | a_{ymh} | a_{ymm} | a_{yms} |
| Fy_Damper | a_{ydh} | a_{ydm} | a_{yds} |
| Fy_Spring | a_{ysh} | a_{ysm} | a_{yss} |
| Fz_Mass | a_{zmh} | a_{zmm} | a_{zms} |
| Fz_Damper | a_{zdh} | a_{zdm} | a_{zds} |
| Fz_Spring | a_{zsh} | a_{zsm} | a_{zss} |
| Tx_Mass | bₓₘₕ | bₓₘₘ | bₓₘₛ |
| Tx_Damper | b_{xdh} | b_{xdm} | b_{xds} |
| Tx_Spring | bₓₛₕ | bₓₛₘ | bₓₛₛ |
| Ty_Mass | b_{ymh} | b_{ymm} | b_{yms} |
| Ty_Damper | b_{ydh} | b_{ydm} | b_{yds} |
| Ty_Spring | b_{ysh} | b_{ysm} | b_{yss} |
| Tz_Mass | b_{zmh} | b_{zmm} | b_{zms} |
| Tz_Damper | b_{zdh} | b_{zdm} | b_{zds} |
| Tz_Spring | b_{zsh} | b_{zsm} | b_{zss} |

In Table 2, “Fx_Mass” represents the setting of (9) described above, that is, the mass coefficient of the force control with respect to the direction along the X axis in the reference coordinate system. “Fx_Spring” represents the setting of (10) described above, that is, the coefficient of elasticity of the force control with respect to the direction along the X axis in the reference coordinate system. “Fx_Damper” represents the setting of (11) described above, that is, the coefficient of viscosity of the force control with respect to the direction along the X axis in the reference coordinate system. “Fx_Spring”, “Fx_Damper”, and “Fx_Mass” in Table 2 respectively correspond to FX1, FX2, and FX3 in the screen X0 shown in FIG. 4.

Parameters with a suffix “y” replacing a suffix “x” of the parameters of “Fx_Mass”, “Fx_Spring”, and “Fx_Damper” respectively represent the settings of (12) to (14) described above, that is, the mass coefficient, the coefficient of elasticity, and the coefficient of viscosity of the force control with respect to the direction along the Y axis in the reference coordinate system. Parameters with a suffix “z” replacing the suffix “x” of the parameters of “Fx_Mass”, “Fx_Spring”, and “Fx_Damper” respectively represent the settings of (15) to (17) described above, that is, the mass coefficient, the coefficient of elasticity, and the coefficient of viscosity of the force control with respect to the direction along the Z axis in the reference coordinate system.

In Table 2, “Tx_Mass” represents the setting of (18) described above, that is, the mass coefficient of the force control with respect to the direction along the U axis in the reference coordinate system. “Tx_Spring” represents the setting of (19) described above, that is, the coefficient of elasticity of the force control with respect to the direction along the U axis in the reference coordinate system. “Tx_Damper” represents the setting of (20) described above, that is, the coefficient of viscosity of the force control with respect to the direction along the U axis in the reference coordinate system. “Tx_Spring”, “Tx_Damper”, and “Tx_Mass” in Table 2 respectively correspond to TX1, TX2, and TX3 in the screen X0 shown in FIG. 4.

Parameters with the suffix “y” replacing the suffix “x” of the parameters of “Tx_Mass”, “Tx_Spring”, and “Tx_Damper” respectively represent the settings of (21) to (23) described above, that is, the mass coefficient, the coefficient of elasticity, and the coefficient of viscosity of the force control with respect to the direction along the V axis in the reference coordinate system. Parameters with the suffix “z” replacing the suffix “x” of the parameters of “Tx_Mass”, “Tx_Spring”, and “Tx_Damper” respectively represent the settings of (24) to (26) described above, that is, the mass coefficient, the coefficient of elasticity, and the coefficient of viscosity of the force control with respect to the direction along the Z axis in the reference coordinate system.

A movement of the control point T by the force control in the direction along the X axis in the reference coordinate system is softer as a part or all of the values of respective (9) to (11) are smaller and is harder as a part or all of the values of respective (9) to (11) are larger. A movement of the control point T by the force control in the direction along the Y axis in the reference coordinate system is softer as a part or all of the values of respective (12) to (14) are smaller and is harder as a part or all of the values of respective (12) to (14) are larger. A movement of the control point T by the force control in the direction along the Z axis in the reference coordinate system is softer as a part or all of the values of respective (15) to (17) are smaller and is harder as a part or all of the values of respective (15) to (17) are larger.

A movement of the control point T by the force control in the direction along the U axis in the reference coordinate system is softer as a part or all of the values of respective (18) to (20) are smaller and is harder as a part or all of the values of respective (18) to (20) are larger. A movement of the control point T by the force control in the direction along the V axis in the reference coordinate system is softer as a part or all of the values of respective (21) to (23) are smaller and is harder as a part or all of the values of respective (21) to (23) are larger. A movement of the control point T by the force control in the direction along the W axis in the reference coordinate system is softer as a part or all of the values of respective (24) to (26) are smaller and is harder as a part or all of the values of respective (24) to (26) are larger.

When the user operates the slide bar SB on the screen P0 shown in FIG. 6 and any position is selected, the setting control section 463 (see FIG. 3) of the control device 46 refers to data equivalent to Table 2 in the storing section 42 and performs processing explained below. For example, when the “hard” is selected, the setting control section 463 of the control device 46 refers to a column of “hard” in Table 2 and acquires values of the first setting items of “Fx_Mass” to “Tz_Spring”. When the “soft” is selected, the control device 46 refers to a column of “soft” in Table 2 and acquires values of the first setting items of “Fx_Mass” to “Tz_Spring”. Further, when the center of the slide bar SB is selected, the control device 46 refers to a column of “normal” in Table 2 and acquires values of the first setting items of “Fx_Mass” to “Tz_Spring”. In the second setting form, the first setting items equivalent to (9) to (26) described above are set as explained above.

As it is seen from the above, the eighteen first setting items of (9) to (26) are set by one second setting item set according to the position of the slide bar SB. Consequently, a user (e.g., a novice or a beginner) nonproficient in the setting of the plurality of first setting items related to the force control in the direct teaching can easily set the eighteen first setting items by moving the position of the slide bar SB. That is, even the user nonproficient in the setting can set characteristics of the robot in the force control to characteristics desired by the user by setting the mass coefficient, the coefficient of elasticity, and the coefficient of viscosity as the first setting items through the second setting form.

### A9. Direct Teaching and Storage of Points

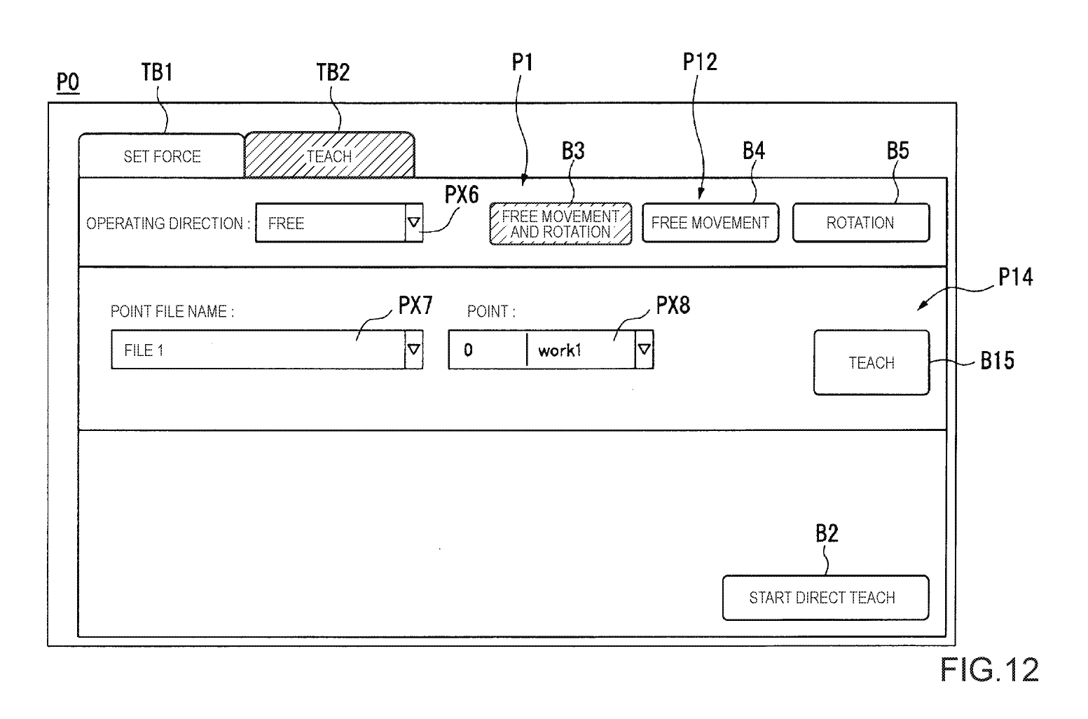

FIG. 12 is a diagram showing an example of the screen P0 at the time when the tab TB2 on the screen P0 shown in FIG. 6 is clicked (tapped) by the user. The tab TB2 is a tab for displaying the region P12 and a region P14 in the region P1. When the tab TB2 is clicked (tapped) by the user (i.e., when selection of the tab TB2 is received), for example, the display control section 461 displays the region P12 and the region P14 in the region P1. The region P1 shown in FIG. 12 is an example of the region P1 at the time when the tab TB2 is clicked by the user. Note that, in this case, the display control section 461 may be configured to display other GUIs in the region P1 instead of one or both of the region P12 and the region P14 or may be configured to display other GUIs in the region P1 in addition to the region P12 and the region P14.

The region P14 includes a pulldown menu PX7, a pulldown menu PX8, and a button B15. Note that the region P14 may include other GUIs instead of a part or all of the pulldown menu PX7, the pulldown menu PX8, and the button B15 or may include other GUIs in addition to the pulldown menu PX7, the pulldown menu PX8, and the button B15.

The pulldown menu PX7 is a GUI including an input field to which the user is capable of inputting a file name. The user is capable of selecting a point file stored in the robot control device 30. When a file name is input to the input field by the user, the display control section 461 displays the file name input by the user in the pulldown menu PX7. The setting control section 463 generates, in the storage region of the robot control device 30, a point file having the file name input by the user.

When the pulldown menu PX7 is clicked (tapped) by the user (i.e., when selection of the pulldown menu PX7 is received), the display control section 461 acquires, from the robot control device 30, information indicating a list including file names of respective one or more point files stored in the robot control device 30. The display control section 461 causes the display section 45 to display the list indicated by the acquired information.

When a certain file name is clicked (tapped) by the user in the list (i.e., when selection of the file name is received), the display control section 461 erases the display of the list from the display section 45 and displays the file name in the input field. Note that the pulldown menu PX7 may be another GUI different from the pulldown menu if the GUI is capable of realizing these functions. In the following explanation, for convenience of the explanation, a file name displayed in the pulldown menu PX7 is referred to as “target point file name”. A point file having the target point file name is referred to as “target point file”.

The “point file” is a file to which a plurality of points belongs (i.e., a directory or a folder higher in order than the plurality of points). The “point” is a file that stores the teaching point information explained above. In this example, teaching point information indicating certain one teaching point is stored in certain one point belonging to the point file. Note that each of one or more points may be a file not belonging to the point file rather than belonging to the point file. Teaching point information indicating two or more teaching points may be stored in certain one point.

The pulldown menu PX8 is a GUI including an input field to which the user is capable of inputting a file name. The user is capable of selecting a point stored in the robot control device 30. When a file name is input to the input field by the user, the display control section 461 displays the file name input by the user in the pulldown menu PX8. The setting control section 463 generates, in the storage region, a point having the file name input by the user as a point belonging to the target point file.

When the pulldown menu PX8 is clicked (tapped) by the user (i.e., when selection of the pulldown menu PX8 is received), the display control section 461 acquires, from the robot control device 30, information indicating a list including file names of respective one or more points belonging to the target point file. The display control section 461 causes the display section 45 to display the list indicated by the acquired information.

When a certain file name is clicked (tapped) by the user in the list (i.e., when selection of the file name is received), the display control section 461 erases the display of the list from the display section 45 and displays the file name in the input field. Note that the pulldown menu PX8 may be another GUI different from the pulldown menu if the GUI is capable of realizing these functions. In the following explanation, for convenience of the explanation, a file name displayed in the pulldown menu PX8 is referred to as “target point name”. A point having the target point name is referred to as “target point”.

The button B15 is a button for storing, in the target point, teaching point information indicating a teaching point associated with teaching point position information indicating the position of the control point T at the time when the button B15 is clicked and teaching point posture information indicating the posture of the control point T at the time when the button B15 is clicked. When the button B15 is clicked (tapped) by the user, the setting control section 463 acquires, from the robot control device 30, information indicating the present position of the control point T as teaching point position information and acquires, from the robot control device 30, information indicating the present posture of the control point T as teaching point posture information. The setting control section 463 generates teaching point information indicating a teaching point associated with the acquired teaching point position information and the acquired teaching point posture information. The setting control section 463 stores the generated teaching point information in the target point. Consequently, the teaching device 40 can teach the teaching point information to the robot control device 30. Note that the button B15 may be another GUI different from the button if the GUI is capable of realizing these functions.

Referring back to FIG. 6, the button B2 is a button for displaying a screen P5 for starting the direct teaching over the screen P0. In a state in which the user is pressing the enable switch when the button B2 is clicked (tapped) by the user, the robot control section 465 controls the robot control device 30 and operates the robot 20 with the force control in the direct teaching. At this time, the robot control device 30 operates the robot 20 with the force control based on the first setting information stored in the twenty-first file, the first setting information stored in the twenty-second file, and the first setting information stored in the twenty-third file.

Note that, in a state the user is not pressing the enable switch when the button B2 is clicked (tapped) by the user, the robot control section 465 does not operate the robot 20. Note that, in this case, the display control section 461 may be configured to display, over the screen P0, an alert screen including a sentence including cautions concerning the direct teaching. The sentence is, for example, “Please start operation while pressing the enable switch. The operation stops when the enable switch is released.” Note that the sentence may be another sentence instead of this.

Note that the screen P0 may include a button for causing the robot control device 30 to perform reset (deletion or cancellation) of drifts accumulated in the force detecting section 21. In this case, when the button is clicked (tapped) by the user, the setting control section 463 causes the robot control device 30 to perform the reset.

### A10. Overview of the First Embodiment

As explained above, the teaching device 40 (or the control device 46) is capable of displaying, on the display section 45, the first setting form capable of setting the plurality of first setting items related to the force control performed using the output from the force detecting section 21 included in the robot 20 and the second setting form capable of setting, as one second setting item, at least two first setting items among the plurality of first setting items included in the first setting form. Consequently, the teaching device 40 can easily set the plurality of first setting items related to the force control.

In the teaching device 40, the first setting items include the mass coefficient, the coefficient of elasticity, and the coefficient of viscosity used in the force control. Consequently, the teaching device 40 can easily set the plurality of first setting items including the mass coefficient, the coefficient of elasticity, and the coefficient of viscosity used in the force control.

In the teaching device 40, at least one of the second setting items is a setting item for setting at least two of the mass coefficient, the coefficient of elasticity, and the coefficient of viscosity among the first setting items. Consequently, the teaching device 40 can easily set at least two of the mass coefficient, the coefficient of elasticity, and the coefficient of viscosity among the first setting items.

In the teaching device 40, the first setting items include a setting item for setting, when the force control is performed, each of directions of axes in which the robot is movable in a coordinate system (in this example, the reference coordinate system indicated by the reference coordinate system information displayed in the pulldown menu PX5). At least one of the second setting items is a setting item for setting, when the force control is performed, a plane defined by two directions among the directions of the axes. Consequently, the teaching device 40 can easily set, when the force control is performed, each of the directions of the axes by setting the plane defined by the two directions among the directions of the axes in which the robot is movable in the coordinate system.

In the teaching device 40, in the second setting form, when the force control is performed, each of the directions of the axes in which the robot 20 is movable in the coordinate system can be set by the second setting item. Consequently, the teaching device 40 can easily set, when the force control is performed, with the second setting form, each of the directions of the axes in which the robot is movable in the coordinate system.

In the teaching device 40, the first setting items include a setting item related to the force control in the direct teaching. Consequently, the teaching device 40 can easily set the setting item related to the force control in the direct teaching.

### B. Second Embodiment

The teaching device 40 can display, on the display section (in the first embodiment, the display section 45), information based on an output from the force detecting section (in the first embodiment, the force detecting section 21) in addition to the content explained in the first embodiment. Such a form is explained below. Note that, in forms explained below, points other than the display of the information based on the output of the force detecting section are the same as those in the first embodiment.

### B1. Form 1 of the Second Embodiment

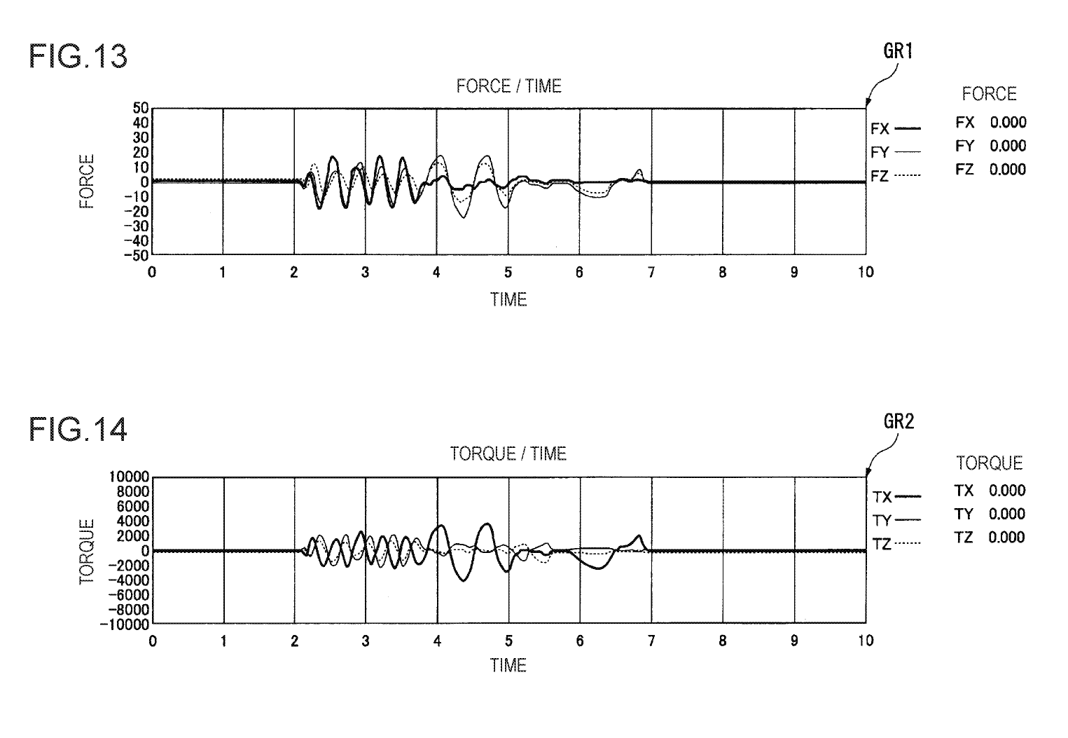

FIG. 13 is a diagram showing an example of a graph GR1. Either one or both of the screen X0 (see FIG. 4) of the first setting form and the screen P0 (see FIG. 6) of the second setting form explained in the first embodiment may further include the graph GR1 shown in FIG. 13. In the following explanation, as an example, only the screen P0 of the second setting form includes the graph GR1.

The graph GR1 is a graph showing temporal changes of the magnitudes of forces acting on the distal end of the movable section A among external forces indicated by force detection information acquired by the robot control device 30 from the force detecting section 21. The vertical axis of the graph GR1 indicates the magnitudes of the forces. The horizontal axis of the graph GR1 indicates an elapsed time from time when the acquisition of the force detection information from the robot control device 30 is started. The graph GR1 is displayed in a region below the region P1 in the screen P0 together with the button B2 and a not-shown button B31 (see FIG. 6). The button B31 is a button for instructing a start of display of the force detection information by the graph.

For example, when the button B31 is clicked (tapped), the display control section 461 acquires, every time a predetermined period elapses, from the robot control device 30, force detection information acquired by the robot control device 30 from the force detecting section 21. The period is, for example, 0.1 second. Note that the period may be a time shorter than 0.1 second or may be a time longer than 0.1 second.

When acquiring the force detection information from the robot control device 30, the display control section 461 specifies the magnitudes of forces acting on the distal end of the movable section A, that is, forces acting in the directions of the respective X axis, Y axis, and Z axis in the reference coordinate system among external forces indicated by the acquired force detection information. The display control section 461 generates the graph GR1 on the basis of the specified magnitudes of the forces and an elapsed time from the click of the button B31. The display control section 461 displays the generated graph GR1 on the screen P0. The display control section 461 performs such display of the graph GR1 every time the display control section 461 acquires force detection information from the robot control device 30.

Note that the display control section 461 may be configured to acquire, every time the predetermined period elapses, from the robot control device 30, force detection information acquired by the robot control device 30 from the force detecting section 21 in other cases such as when the screen P0 is displayed instead of when the button B31 is clicked (tapped).

### B2. Form 2 of the Second Embodiment

FIG. 14 is a diagram showing an example of a graph GR2. Either one or both of the screen X0 (see FIG. 4) of the first setting form and the screen P0 (see FIG. 6) of the second setting form explained in the first embodiment may further include the graph GR2 shown in FIG. 14. In the following explanation, as an example, only the screen P0 of the second setting form includes the graph GR2 in addition to the graph GR1 explained above.

The graph GR2 is a graph showing temporal changes of the magnitudes of moments (torques) acting on the distal end of the movable section A among external forces indicated by the force detection information acquired by the robot control device 30 from the force detecting section 21. The vertical axis of the graph GR2 indicates the magnitudes of the moments. The horizontal axis of the graph GR2 indicates an elapsed time from time when the acquisition of the force detection information from the robot control device 30 is started. The graph GR2 is displayed in a region below the region P1 on the screen P0 together with the button B2 and the graph GR1 (see FIG. 6).

For example, when the button B31 is clicked (tapped), the display control section 461 acquires, every time a predetermined period elapses, from the robot control device 30, force detection information acquired by the robot control device 30 from the force detecting section 21. The period is, for example, 0.1 second. Note that the period may be a time shorter than 0.1 second or may be a time longer than 0.1 second.

When acquiring the force detection information from the robot control device 30, the display control section 461 specifies the magnitudes of moments acting on the distal end of the movable section A, that is, moments acting in the directions of the respective U axis, V axis, and W axis in the reference coordinate system among external forces indicated by the acquired force detection information. The display control section 461 generates the graph GR2 on the basis of the specified magnitudes of the moments and an elapsed time from the click of the button B31. The display control section 461 displays the generated graph GR2 on the screen P0. The display control section 461 performs such display of the graph GR2 every time the display control section 461 acquires force detection information from the robot control device 30. Each of the graph GR1 and the graph GR2 is an example of information based on an output from the force detecting section.

By performing such processing, in the direct teaching, the user can set a position and a posture of the control point T of the robot 20 while confirming that the robot system 1 including the control device 46 is functioning.

### B3. Form 3 of the Second Embodiment

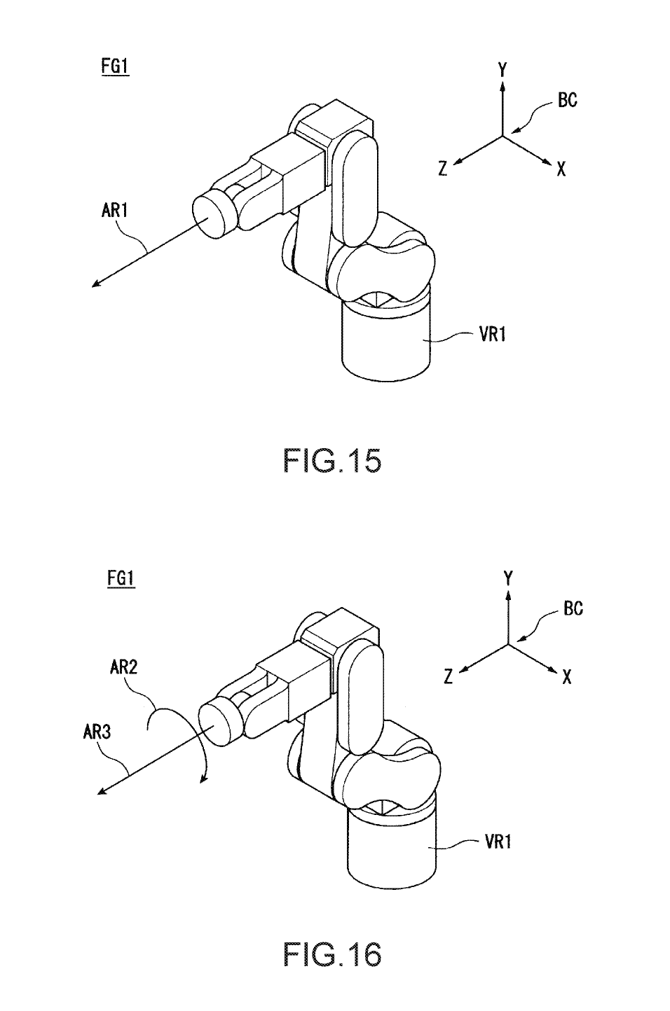

FIG. 15 is a diagram showing an example of a screen FG1 that can be included in the screen P0. Either one or both of the screen X0 (see FIG. 4) of the first setting form and the screen P0 (see FIG. 6) of the second setting form explained in the first embodiment may include the screen FG1 shown in FIGS. 15 to 17. In the following explanation, as an example, on the screen P0 includes the screen FG1.

The screen FG1 is a screen including an image showing, on the basis of the first setting information stored in each of the twenty-second file and the twenty-third file, a direction in which the control point T is operable. The screen FG1 includes, for example, a virtual robot, which is a virtual robot 20 set in a virtual space, a reference coordinate system image representing the reference coordinate system, and an operable direction image representing the direction. Note that the screen FG1 may include other images instead of a part or all of the reference coordinate system image and the operable direction image or may include other images in addition to the reference coordinate system image and the operable direction image.

An image VR1 shown in FIG. 15 is an example of the virtual robot. An image BC shown in FIG. 15 is an example of the reference coordinate system image. An image AR1 shown in FIG. 15 (an arrow image in FIG. 15) is an example of the operable direction image. The display control section 461 generates the screen FG1 on the basis of the reference coordinate system and the first setting item set by the second setting item in the region P12. The screen FG1 may be a two-dimensional image or may be a three-dimensional image.

The screen FG1 is displayed on the screen P0. Therefore, by viewing the screen FG1, the user can easily learn the direction in which the control point T can be operated in the direct teaching. As a result, even when the user is nonproficient in the setting of the first setting items, the user can set the first setting items.

In the example shown in FIG. 15, the screen FG1 indicates that the control point T can perform a translational motion only in a direction along the direction of the Z axis in the reference coordinate system. The screen FG1 shown in FIG. 15 is displayed in, for example, a region below the region P1 on the screen P0 (see FIG. 6).

By performing such processing, even a user nonproficient in the setting of the first setting items can easily perform, using the screen P0 of the second setting form displayed on the display section 45, setting of a setting value of the first setting item for setting one direction among the directions of axes in a three-dimensional orthogonal coordinate system as a movable direction.

FIG. 16 is a diagram showing another example of the screen FG1 included in the screen P0. In the example shown in FIG. 16, the screen FG1 indicates that the control point T is can perform a rotating motion only in a direction along the direction of the W axis in the reference coordinate system, that is, a direction indicated by an image AR2 (one of two arrow images in FIG. 16). Note that an image AR3 shown in FIG. 16 represents an axis representing the rotation center of the rotating motion indicated by the image AR2, that is, the Z axis in the reference coordinate system. The screen FG1 shown in FIG. 16 is displayed in, for example, a region below the region P1 on the screen P0 (see FIG. 6).

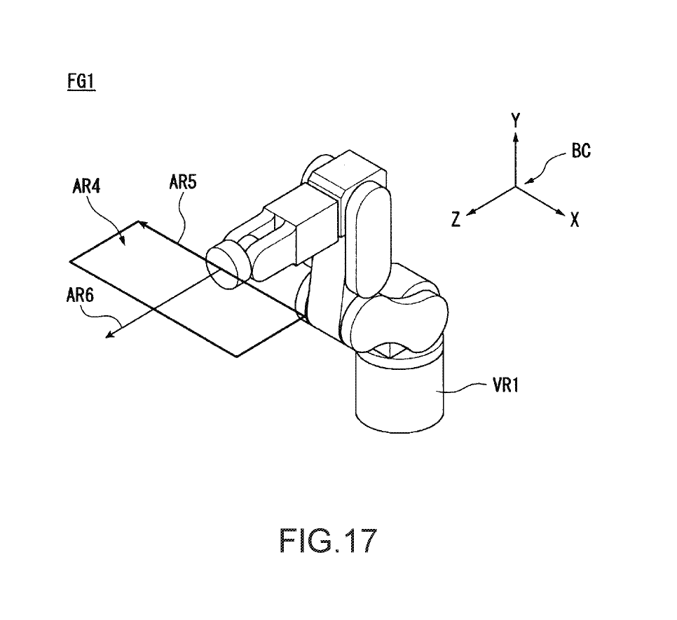

FIG. 17 is a diagram showing still another example of the screen FG1 that can be included in the screen P0. In the example shown in FIG. 17, the screen FG1 indicates that the control point T can perform a translating motion only in a direction along a plane indicated by an image AR4, that is, a plane defined by the X axis and the Z axis in the reference coordinate system. Note that an image AR5 shown in FIG. 17 represents the X axis and an image AR6 represents the Z axis. The screen FG1 is an example of information indicating at least one of a direction in which the robot is movable and a plane on which the robot is movable. The screen FG1 shown in FIG. 17 is displayed in, for example, a region below the region P1 on the screen P0 (see FIG. 6).

By performing such processing, even a user nonproficient in the setting of the first setting items can set, using the screen P0 of the second setting form displayed on the display section 45, the control point T of the robot 20 while intuitively grasping a plane on which the robot 20 is movable. Note that the display control section 461 may be configured to move the virtual robot according to a motion of the real robot 20 on the screen FG1.

### B4. Overview of the Second Embodiment

As explained above, the teaching device 40 (i.e., the control device 46) is capable of displaying, on the display section (in the example explained above, the display section 45), information based on an output from the force detecting section (in the example explained above, the force detecting section 21). Consequently, the teaching device 40 can easily set the plurality of first setting items on the basis of the information based on the output of the force detecting section.

The teaching device 40 is capable of displaying, on the display section, information indicating at least one of the direction in which the robot 20 is movable and the plane on which the robot 20 is movable. Consequently, the teaching device 40 can easily set a plurality of first setting items on the basis of the information indicating at least one of the direction in which the robot 20 is movable and the screen on which the robot 20 is movable.

Note that the first setting items explained above may not include the mass coefficient, the coefficient of elasticity, and the coefficient of viscosity used in the force control in the direct teaching.

The second setting items explained above may not include the setting items for setting at least two of the mass coefficient, the coefficient of elasticity, and the coefficient of viscosity among the first setting items.

The first setting items explained above may not include the setting item for setting, when the force control is performed, each of the direction of the axes in which the robot 20 is movable in the reference coordinate system. The second setting items explained above may not include the setting item for setting the plane defined by two directions among the directions of the axes in the reference coordinate system.

The second setting form explained above may not include the second setting item for setting, when the force control is performed, each of the directions of the axes in which the robot 20 is movable in the reference coordinate system.

The display control section 461 may not display, on the display section 45, the information based on the output of the force detecting section 21.

The display control section 461 may not display, on the display section 45, the information indicating at least one of the direction in which the robot 20 is movable and the plane on which the robot 20 is movable.

The first setting items explained above may not include the setting item related to the force control in the direct teaching.

### C. Third Embodiment

An aspect of the invention is directed to a control device including a display control section capable of displaying, on a display section, a first setting form capable of setting a plurality of first setting items related to force control performed using an output from a force detecting section included in a robot and a second setting form capable of setting, as one second setting item, at least a pair of the first setting items among the plurality of first setting items included in the first setting form.

With this configuration, the control device is capable of displaying, on the display section, the first setting form capable of setting the plurality of first setting items related to the force control performed using the output from the force detecting section included in the robot and the second setting form capable of setting, as the one second setting item, the at least two first setting items among the plurality of first setting items included in the first setting form. Consequently, the control device can easily set the plurality of first setting items related to the force control.

In the control device according to the aspect of the invention, the first setting item may include a mass coefficient, a coefficient of elasticity, and a coefficient of viscosity used in the force control.

With this configuration, in the control device, the first setting item includes the mass coefficient, the coefficient of elasticity, and the coefficient of viscosity used in the force control. Consequently, the control device can easily set the plurality of first setting items including the mass coefficient, the coefficient of elasticity, and the coefficient of viscosity used in the force control.

In the control device according to the aspect of the invention, at least one of a plurality of the second setting items may be a setting item for setting at least two of the mass coefficient, the coefficient of elasticity, and the coefficient of viscosity among the first setting items.

With this configuration, in the control device, at least one of the second setting items is the setting item for setting at least two of the mass coefficient, the coefficient of elasticity, and the coefficient of viscosity among the first setting items. Consequently, the control device can easily set at least two of the mass coefficient, the coefficient of elasticity, and the coefficient of viscosity among the first setting items.

In the control device according to the aspect of the invention, the first setting items include a setting item for setting, when the force control is performed, each of directions of axes in which the robot is movable in a coordinate system. At least one of the second setting items may be a setting item for setting, when the force control is performed, a plane defined by two directions among the directions of the axes.

With this configuration, in the control device, the first setting items include the setting item for setting, when the force control is performed, each of the directions of the axes in which the robot is movable in the coordinate system. At least one of the second setting items is the setting item for setting, when the force control is performed, the plane defined by the two directions among the directions of the axes. Consequently, the control device can easily set each of the directions of the axes by setting, when the force control is performed, the plane defined by the two directions among the directions of the axes in which the robot is movable in the coordinate system.

In the control device according to the aspect of the invention, the second setting form may be capable of setting, when the force control is performed, with the second setting item, each of the directions of the axes in which the robot is movable in the coordinate system.

With this configuration, in the control device, the second setting form is capable of setting, when the force control is performed, with the second setting item, each of the directions of the axes in which the robot is movable in the coordinate system. Consequently, the control device can easily set, when the force control is performed, with the second setting form, each of the directions of the axes in which the robot is movable in the coordinate system.

In the control device according to the aspect of the invention, the display control section may be capable of displaying, on the display section, information based on an output from the force detecting section.

With this configuration, the control device is capable of displaying, on the display section, the information based on the output from the force detecting section. Consequently, the control device can easily set the plurality of first setting items on the basis of the information based on the output of the force detecting section.

In the control device according to the aspect of the invention, the display control section may be capable of displaying, on the display section, information indicating at least one of a direction in which the robot is movable and a plane on which the robot is movable.

With this configuration, the control device is capable of displaying, on the display section, the information indicating at least one of the direction in which the robot is movable and the plane on which the robot is movable. Consequently, the control device can easily set the plurality of first setting items on the basis of at least one of the direction in which the robot is movable and the plane on which the robot is movable.

In the control device according to the aspect of the invention, the first setting items may include a setting item related to the force control in the direct teaching.

With this configuration, in the control device, the first setting items include the setting item related to the force control in the direct teaching. Consequently, the control device can easily set the setting item related to the force control in the direct teaching.

Another aspect of the invention is directed to a teaching device including the control device explained above, the teaching device teaching a motion to the robot. Therefore, the teaching device is capable of displaying, on the display section, the first setting form capable of setting the plurality of first setting items related to the force control performed using the output from the force detecting section included in the robot and the second setting form capable of setting, as the one second setting item, the at least two first setting items among the plurality of first setting items included in the first setting form. Consequently, the teaching device can easily set the plurality of first setting items related to the force control.

Still another aspect of the invention is directed to a robot system including: the teaching device explained above; and the robot that is taught a motion by the teaching device. Therefore, the robot system is capable of displaying, on the display section, the first setting form capable of setting the plurality of first setting items related to the force control performed using the output from the force detecting section included in the robot and the second setting form capable of setting, as the one second setting item, the at least two first setting items among the plurality of first setting items included in the first setting form. Consequently, the robot system can easily set the plurality of first setting items related to the force control.

According to the above explanation, the control device, the teaching device, and the robot system are capable of displaying, on the display section, the first setting form capable of setting the plurality of first setting items related to the force control performed using the output from the force detecting section included in the robot and the second setting form capable of setting, as the one second setting item, the at least two first setting items among the plurality of first setting items included in the first setting form. Consequently, the control device, the teaching device, and the robot system can easily set the plurality of first setting items.

### D. Fourth Embodiment

The present disclosure can also be realized in forms explained below.

(1) According to an aspect of the invention, a control device that controls a robot is provided. The control device includes: a setting control section configured to set, by referring to a storing section having stored therein a plurality of sets of information in which setting values of at least two first setting items among a plurality of first setting items related to force control performed using an output of a force detecting section included in the robot and one setting value of a second setting item are associated, when a setting value of the second setting item is selected, setting values of the at least two first setting items associated with the selected setting value of the second setting item; and a display control section capable of displaying, on a display section, a first setting form capable of individually setting setting values of the plurality of first setting items and a second setting form incapable of individually setting the setting values of the at least two first setting items, the setting values of which are associated with the one setting value of the second setting item, and capable of setting the setting value of the second setting item.

With such a form, a user nonproficient in the setting of the first setting items can easily set the setting values of the plurality of first setting items by setting the setting value of the second setting item using the second setting form displayed on the display section. On the other hand, a user proficient in the setting of the first setting items can appropriately set, by individually setting the setting values of the first setting items using the first setting form displayed on the display section, the setting values of the plurality of first setting items such that the performance of the robot can be exhibited. Therefore, the user nonproficient in the setting can easily set setting values. The user proficient in the setting can appropriately set a plurality of setting values.

(2) In the control device, the first setting items may include a mass coefficient, a coefficient of elasticity, and a coefficient of viscosity used in the force control. With such a form, a user can set characteristics of the robot in the force control to characteristics desired by the user by setting the mass coefficient, the coefficient of elasticity, and the coefficient of viscosity serving as the first setting items.

(3) In the control device, in the storing section, a setting value of a singularity of the second setting item may be associated with setting values of at least a pair of the first setting items among the mass coefficient, the coefficient of elasticity, and the coefficient of viscosity. With such a form, even a user nonproficient in the setting can set characteristics of the robot in the force control to characteristics desired by the user by setting the mass coefficient, the coefficient of elasticity, and the coefficient of viscosity serving as the first setting items through the second setting form.

(4) In the control device, the first setting items may include a setting item for setting, in the force control, a direction of an axis that a moving direction of the robot can include as a direction component among directions of three axes of a three-dimensional orthogonal coordinate system. In the storing section, a setting value of a singularity of the second setting item may be associated with setting values of at least a pair of the first setting items for setting directions of two axes that the moving direction of the robot can include as direction components. With such a form, a user nonproficient in the setting of the first setting items can easily perform, using the second setting form displayed on the display section, setting of the setting values of the two first setting items for enabling the robot to move in a direction including, as direction components, two directions among the directions of the axes in the three-dimensional orthogonal coordinate system.

(5) In the control device, the display control section may be capable of displaying, in the second setting form, on the display section, information indicating a plane defined by the two axes that the moving direction of the robot can include as a direction component in the three-dimensional orthogonal coordinate system. With such a form, a user nonproficient in the setting of the first setting items can set, using the second setting form displayed on the display section, a position of a component of the robot while intuitively grasping a plane on which the robot is movable.

(6) In the control device, the first setting items may include a setting item for setting a direction of an axis that a moving direction of the robot can include as a direction component among directions of three axes of a three-dimensional orthogonal coordinate system. In the storing section, a setting value of at least a singularity of the second setting item may be associated with setting values of at least a pair of the first setting items for setting one direction among the directions of the three axes as a direction in which the robot is movable. With such a form, a user nonproficient in the setting of the first setting items can easily perform, using the second setting form displayed on the display section, setting of the setting values of at least the two first setting items for setting the one direction among the directions of the axes in the three-dimensional orthogonal coordinate system as the movable direction.

In the control device, the display control section may be capable of displaying, in the second setting form, on the display section, information indicating one direction in which the robot is movable in the three-dimensional orthogonal coordinate system. With such a form, a user nonproficient in the setting of the first setting items can set, using the second setting form displayed on the display section, a position of a component of the robot while intuitively grasping a direction in which the robot is movable.

(8) In the control device, the display control section may be capable of displaying, on the display section, information based on the output of the force detecting section when direct teaching is performed on the robot using the force control. With such a form, in the direct teaching, the user can set a position and a posture of a component of the robot while confirming that the control device is functioning.

(9) In the control device, the first setting items may include a setting item related to the force control performed in direct teaching.

(10) According to another aspect of the invention, a teaching device including the control device according to the aspect, the teaching device teaching a motion to the robot is provided.

(11) According to still another aspect of the invention, a robot system including: the teaching device according to the aspect; and the robot that is taught a motion by the teaching device is provided.

### E. Still other Embodiments

(1) In the embodiments explained above, the first setting items include the mass coefficient, the coefficient of elasticity, and the coefficient of viscosity used in the force control. However, the first setting items may not include one or more of the mass coefficient, the coefficient of elasticity, and the coefficient of viscosity, for example, may not include the mass coefficient.

(2) In the embodiments, a part of the setting values of the second setting item is associated with the setting values of the mass coefficient, the coefficient of elasticity, and the coefficient of viscosity of the first setting items. However, in the present disclosure, the setting value of the second setting item may be not associated with the setting values of the mass coefficient, the coefficient of elasticity, and the coefficient of viscosity of the first setting items. For example, the setting item of the second setting item may be not associated with the setting values of the mass coefficient, the coefficient of elasticity, and the coefficient of viscosity and may be associated with a setting value of the first setting item for setting a direction of an axis of a coordinate system that the moving direction of the robot can include as a direction component.

(3) In the embodiments, a part of the setting values of the second setting item is associated with the setting values of the at least two first setting items for setting the directions of the two axes that the moving direction of the robot includes as the direction components. However, in the present disclosure, the setting value of the second setting item may not be associated with the setting values of the at least two first setting items for setting the directions of the two axes that the moving direction of the robot can include as the direction components. For example, the setting value of the second setting item may not be associated with the setting value of the first setting item for setting the direction of the axis of the coordinate system that the moving direction of the robot can include as the direction component and may be associated with the setting values of the mass coefficient, the coefficient of elasticity, and the coefficient of viscosity of the first setting items.

The setting value of the second setting item may be associated with the setting value of the first setting item for setting the direction of the axis of the coordinate system that the moving direction of the robot can include as the direction component and setting values of the first setting items other than the setting values of the mass coefficient, the coefficient of elasticity, and the coefficient of viscosity of the first setting items.

(4) In the embodiments, a part of the setting values of the second setting item is associated with the setting value of the first setting item for setting one direction among the directions of the three axes of the coordinate system as the direction in which the robot 20 is movable. However, in the present disclosure, the setting value of the second setting item may be not associated with the setting value of the first setting item for setting one direction among the directions of the three axes of the coordinate system as the direction in which the robot 20 is movable. For example, the setting value of the second setting item may be not associated with the setting value of the first setting item for setting one direction among the directions of the three axes of the coordinate system as the direction in which the robot 20 is movable and may be associated with the setting values of the mass coefficient, the coefficient of elasticity, and the coefficient of viscosity of the first setting items.

(5) In the embodiments, the first setting items include the setting items related to the force control performed in the direct teaching. However, in the present disclosure, the first setting items may not include the setting items related to the force control performed in the direct teaching. The first setting items may include setting items related to force control at the time when the robot performs work.

(6) The control device of the robot maybe configured by a plurality of processors. For example, the robot system explained in this specification can also be realized in a form in which one or more personal computers and a cloud service provided via a network environment such as a LAN are mutually connected besides the robot 20, the robot control device 30, and the teaching device 40. The personal computers respectively include processors and memories. The processors and the memories can be used in the cloud service as well. The processors execute computer-executable commands. It is possible to realize the robot control device and the teaching device and the control device including the robot control device and the teaching device using a part or all of the plurality of processors.

(7) At least parts of the robot control device 30 and the teaching device 40 can be housed in the robot 20. In this example as well, it is possible to realize the robot control device and the teaching device and the control device including the robot control device and the teaching device using a part or all of the plurality of processors.

(8) The embodiments of the invention are explained above with reference to the drawings. However, specific configurations are not limited to the embodiments. The embodiments may be, for example, changed, replaced, and deleted without departing from the spirit of the invention.

A computer program for realizing the functions of any components in the devices (e.g., the teaching device 40, the control device 46, and the robot control device 30) explained above may be recorded in a computer-readable recording medium. The computer program may be read and executed by a computer system. Note that the “computer system” includes an OS (Operating System) and hardware such as peripheral devices. The “computer-readable recording medium” refers to portable media such as a flexible disk, a magneto-optical disk, a ROM, and a CD (Compact Disk)-ROM and a storage device such as a hard disk incorporated in the computer system. Further, the “computer-readable recording medium” also includes a recording medium that retains the computer program for a fixed time such as a volatile memory (RAM) inside a computer system functioning as a server or a client to which the computer program is transmitted via a network such as the Internet or a communication line such as a telephone line.

The computer program may be transmitted from the computer system, in which the computer program is stored in the storage device or the like, to another computer system via a transmission medium or by a transmission wave in the transmission medium. The “transmission medium” for transmitting the computer program refers to a medium having a function of transmitting information like a network (a communication network) such as the Internet or a communication line (a communication wire) such as a telephone line.

The computer program may be a computer program for realizing a part of the functions explained above. Further, the computer program may be a computer program that can realize the functions explained above through a combination with a computer program already recorded in the computer system, a so-called differential file (differential program).

The entire disclosures of Japanese Patent Application No. 2017-054065, filed Mar. 21, 2017, and No. 2018-010213, filed January 25, 2018 are expressly incorporated by reference herein.

What is claimed is:

1. A control device comprising:
a processor that is configured to execute computer-executable instructions so as to control a robot,
wherein the processor is configured to:
set, by referring to a memory having stored therein a plurality of sets of information in which setting values of at least two first setting items among a plurality of first setting items related to force control performed using an output of a force sensor included in the robot and one setting value of a second setting item are associated, when a setting value of the second setting item is selected, setting values of the at least two first setting items associated with the selected setting value of the second setting item; and
display, on a display, a first setting form capable of individually setting setting values of the plurality of first setting items and a second setting form incapable of individually setting the setting values of the at least two first setting items, the setting values of which are associated with the one setting value of the second setting item, and capable of setting the setting value of the second setting item.

2. The control device according to claim 1, wherein the first setting items include amass coefficient, a coefficient of elasticity, and a coefficient of viscosity used in the force control.

3. The control device according to claim 2, wherein a setting value of a singularity of the second setting item is associated with setting values of at least a pair of the first setting items among the mass coefficient, the coefficient of elasticity, and the coefficient of viscosity.

4. The control device according to claim 1, wherein
the first setting items include a setting item for setting, in the force control, a direction of an axis that a moving direction of the robot can include as a direction component among directions of three axes of a three-dimensional orthogonal coordinate system, and
in the memory, a setting value of a singularity of the second setting item is associated with setting values of at least a pair of the first setting items for setting directions of two axes that the moving direction of the robot can include as direction components.

5. The control device according to claim 4, wherein the processor is configured to be capable of displaying, in the second setting form, on the display section, information indicating a plane defined by the two axes that the moving direction of the robot can include as a direction component in the three-dimensional orthogonal coordinate system.

6. The control device according to claim 1, wherein
the first setting items include a setting item for setting a direction of an axis that a moving direction of the robot can include as a direction component among directions of three axes of a three-dimensional orthogonal coordinate system, and
in the memory, a setting value of at least a singularity of the second setting item is associated with setting values of at least a pair of the first setting items for setting one direction among the directions of the three axes as a direction in which the robot is movable.

7. The control device according to claim 6, wherein the processor is configured to be capable of displaying, in the second setting form, on the display, information indicating one direction in which the robot is movable in the three-dimensional orthogonal coordinate system.

8. The control device according to claim 1, wherein the processor is configured to be capable of displaying, on the display section, information based on the output of the force sensor when direct teaching is performed on the robot using the force control.

9. The control device according to claim 1, wherein the first setting items include a setting item related to the force control performed in direct teaching.

10. A teaching device teaching a motion to a robot comprising:
a control device including a processor that is configured to execute computer-executable instructions so as to control the robot,
wherein the processor is configured to:
set, by referring to a memory having stored therein a plurality of sets of information in which setting values of at least two first setting items among a plurality of first setting items related to force control performed using an output of a force sensor included in the robot and one setting value of a second setting item are associated, when a setting value of the second setting item is selected, setting values of the at least two first setting items associated with the selected setting value of the second setting item; and
display on a display, a first setting form capable of individually setting setting values of the plurality of first setting items and a second setting form incapable of individually setting the setting values of the at least two first setting items, the setting values of which are associated with the one setting value of the second setting item, and capable of setting the setting value of the second setting item.
to claim 1, the teaching device teaching a motion to the robot.

11. A teaching device according to claim 10, wherein the first setting items include a mass coefficient, a coefficient of elasticity, and a coefficient of viscosity used in the force control.

12. A teaching device according to claim 11, wherein a setting value of a singularity of the second setting item is associated with setting values of at least a pair of the first setting items among the mass coefficient, the coefficient of elasticity, and the coefficient of viscosity.

13. A teaching device according to claim 10, wherein
the first setting items include a setting item for setting, in the force control, a direction of an axis that a moving direction of the robot can include as a direction component among directions of three axes of a three-dimensional orthogonal coordinate system, and
in the memory, a setting value of a singularity of the second setting item is associated with setting values of at least a pair of the first setting items for setting directions of two axes that the moving direction of the robot can include as direction components.

14. A teaching device according to claim 13, wherein the processor is configured to be capable of displaying, in the second setting form, on the display, information indicating a plane defined by the two axes that the moving direction of the robot can include as a direction component in the three-dimensional orthogonal coordinate system.

15. A teaching device according to claim 10, wherein
the first setting items include a setting item for setting a direction of an axis that a moving direction of the robot can include as a direction component among directions of three axes of a three-dimensional orthogonal coordinate system, and
in the memory, a setting value of at least a singularity of the second setting item is associated with setting values of at least a pair of the first setting items for setting one direction among the directions of the three axes as a direction in which the robot is movable.

16. A teaching device according to claim 15, wherein the processor is configured to be capable of displaying, in the second setting form, on the display, information indicating one direction in which the robot is movable in the three-dimensional orthogonal coordinate system.

17. A teaching device according to claim 10, wherein the processor is configured to be capable of displaying, on the display, information based on the output of the force sensor when direct teaching is performed on the robot using the force control.

18. A teaching device according to claim 10, wherein the first setting items include a setting item related to the force control performed in direct teaching.

19. A robot system comprising:
a teaching device including a control device; and
a robot that is taught a motion by the teaching device,
wherein the control device includes a processor that is configured to execute computer-executable instructions so as to control the robot provided with a manipulator, and
the processor is configured to:
set, by referring to a memory having stored therein a plurality of sets of information in which setting values of at least two first setting items among a plurality of first setting items related to force control performed using an output of a force sensor included in the robot and one setting value of a second setting item are associated, when a setting value of the second setting item is selected, setting values of the at least two first setting items associated with the selected setting value of the second setting item; and
display on a display, a first setting form capable of individually setting setting values of the plurality of first setting items and a second setting form incapable of individually setting the setting values of the at least two first setting items, the setting values of which are associated with the one setting value of the second setting item, and capable of setting the setting value of the second setting item.

20. A robot system according to claim 19, wherein the first setting items include a mass coefficient, a coefficient of elasticity, and a coefficient of viscosity used in the force control.
